(19) United States
(12) Patent Application Publication
(10) Pub. No.: US 2026/0189994 A1
(43) Pub. Date: Jul. 2, 2026

(54) INTRA-SECONDARY NODE CONDITIONAL PRIMARY SCELL CHANGE CONFIGURATION

(71) Applicant: Telefonaktiebolaget LM Ericsson (publ), Stockholm (SE)

(72) Inventors: Jens BERGQVIST, LINKÖPING (SE); Cecilia EKLÖF, TÄBY (SE); Liwei QIU, TÄBY (SE)

(73) Assignee: Telefonaktiebolaget LM Ericsson (publ), Stockholm (SE)

(21) Appl. No.: 19/127,122

(22) PCT Filed: Oct. 31, 2023
(86) PCT No.: PCT/SE2023/051084

§ 371 Date: May 4, 2025

Related U.S. Application Data
(60) Provisional application No. 63/422,200, filed on Nov. 3, 2022.

(51) Int. Cl. H04W 36/00; H04W 36/04; H04W 36/36

(52) U.S. Cl. CPC H04W 36/0069; H04W 36/0072; H04W 36/008355; H04W 36/04; H04W 36/362

(57) ABSTRACT

A method performed by a User Equipment, UE, operating in Dual Connectivity, DC, with a Master Node, MN, and a serving Secondary Node, SN, the method comprising: receiving, from the MN, a conditional PSCell change, CPC, configuration for a first candidate target PSCell of the serving SN, wherein the CPC configuration is in MN format.

### TECHNICAL FIELD

This disclosure relates to the field of telecommunication networks, and in particular to methods and apparatuses for intra-Secondary Node conditional Primary SCell change.

### BACKGROUND

### 3GPP Dual Connectivity

In Third Generation Partnership Project (3GPP) Release 12 (Rel-12), the Long Term Evolution (LTE) feature Dual Connectivity (DC) was introduced, to enable the User Equipment (UE) to be connected in two cell groups, each controlled by an LTE access node, eNBs, labelled as the Master eNB (MeNB) and the Secondary eNB (SeNB). The UE only has one Radio Resource Control (RRC) connection with the network. In 3GPP, the Dual Connectivity solution has since then been evolved and is now also specified for New Radio (NR) as well as between LTE and NR. Multi-connectivity (MC) is the case when there are more than 2 nodes involved. With introduction of 5G, the term MR-DC (Multi-Radio Dual Connectivity, see also 3GPP Technical Specification (TS) 37.340 version 17.2.0) was defined as a generic term for all dual connectivity options which includes at least one NR access node. Using the MR-DC generalized terminology, the UE is connected in a Master Cell Group (MCG), controlled by the Master Node (MN), and in a Secondary Cell Group (SCG) controlled by a Secondary Node (SN).

Further, in MR-DC, when dual connectivity is configured for the UE, within each of the two cell groups, MCG and SCG, carrier aggregation may be used as well. In this case, within the Master Cell Group, MCG, controlled by the master node (MN), the UE may use one Primary Cell (PCell) and one or more Secondary Cell(s) (SCell(s)). And within the Secondary Cell Group, SCG, controlled by the secondary node (SN), the UE may use one PSCell (known as the primary SCG cell in NR or the primary secondary cell in LTE) and one or more SCell(s). This combined case is illustrated in FIG. 1. FIG. 1 is a schematic illustrating dual connectivity combined with carrier aggregation in MR-DC. In NR, the primary cell of a master or secondary cell group is sometimes also referred to as the Special Cell (SpCell). Hence, the SpCell in the MCG is the PCell and the SpCell in the SCG is the PSCell.

There are different ways to deploy 5G network with or without interworking with LTE (also referred to as Evolved Universal Terrestrial Radio Access (E-UTRA)) and evolved packet core (EPC). In principle, NR and LTE can be deployed without any interworking, denoted by NR stand-alone (SA) operation, also known as Option 2, that is gNB (base station in NR) can be connected to 5G core network (5GC) and eNB (base station in LTE) can be connected to EPC with no interconnection between the two, also known as Option 1.

On the other hand, the first supported version of NR uses dual connectivity, denoted as EN-DC (Evolved Universal Terrestrial Radio Access Network (E-UTRAN) NR Dual Connectivity), also known as Option 3, as depicted in FIG. 2. In such a deployment, dual connectivity between NR and LTE is applied, where the UE is connected with both the LTE radio interface (LTE Uu in FIG. 2) to an LTE access node and the NR radio interface (NR Uu in FIG. 2) to an NR access node. Further, in EN-DC, the LTE access node acts as the master node (in this case known as the Master eNB, MeNB), controlling the master cell group, MCG, and the NR access node acts as the secondary node (in this case sometimes also known as the Secondary gNB, SgNB), controlling the secondary cell group, SCG. The SgNB may not have a control plane connection to the core network (EPC) which instead is provided MeNB and in this case the NR. This is also called as “Non-standalone NR” or, in short, “NSA NR”. Notice that in this case the functionality of an NR cell is limited and would be used for connected mode UEs as a booster and/or diversity leg, but an RRC_IDLE UE cannot camp on these NR cells.

With introduction of 5G core (5GC), other options may be also valid. As mentioned above, option 2 supports stand-alone NR deployment where gNB is connected to 5GC. Similarly, LTE can also be connected to 5GC using option 5 (also known as eLTE, E-UTRA/5GC, or LTE/5GC and the node can be referred to as a Next Generation evolved Node B (NG-eNB)). In these cases, both NR and LTE are seen as part of the Next Generation Radio Access Network (NG-RAN) (and both the ng-eNB and the gNB can be referred to as NG-RAN nodes).

It is worth noting that, there are also other variants of dual connectivity between LTE and NR which have been standardized as part of NG-RAN connected to 5GC. Under the MR-DC umbrella, there are the following options:
EN-DC (Option 3): LTE is the master node and NR is the secondary node (EPC core network (CN) employed, as depicted in FIG. 2)
NE-DC (Option 4): NR is the master node and LTE is the secondary (5GCN employed).
NGEN-DC (Option 7): LTE is the master node and NR is the secondary (5GCN employed).
NR-DC (variant of Option 2): Dual connectivity where both the master node, MN, controlling the MCG, and the secondary node, SN, controlling the SCG, are NR (5GCN employed, as depicted in FIG. 3).

### Conditional Handover (CHO)

In 3GPP Rel-16, the conditional handover was standardized as a solution to increase the robustness at handover. In order to avoid the undesired dependence on the serving radio link upon the time (and radio conditions) where the UE should execute the handover, the possibility to provide RRC signaling for the handover to the UE earlier was standardized. It is possible to associate the handover (HO) command with a condition e.g. based on radio conditions possibly similar to the ones associated to an A3 event, where a given neighbour becomes X dB better than target. As soon as the condition is fulfilled, the UE executes the handover in accordance with the provided handover command.

Such a condition could e.g. be that the quality of the target cell or beam becomes X dB stronger than the serving cell. The threshold Y used in a preceding measurement reporting event should then be chosen lower than the one in the handover execution condition. This allows the serving cell to prepare the handover upon reception of an early measurement report and to provide the RRCConnectionReconfiguration with mobilityControlInfo (or the RRCReconfiguration with reconfigurationWithSync) at a time when the radio link between the source cell and the UE is still stable. The execution of the handover is done at a later point in time (and threshold), which is considered optimal for the handover execution.

FIG. 4 is a signaling diagram showing conditional handover execution. FIG. 4 depicts an example with just a serving and a target cell. In practice there may often be many cells or beams that the UE reported as possible candidates based on its preceding Radio Resource Management (RRM) measurements. The network should then have the freedom to issue conditional handover commands for several of those candidates. The RRCConnectionReconfiguration or RRCReconfiguration message for each of those candidates may differ not just concerning the target cell but also e.g. in terms of the HO execution condition (reference signal (RS) to measure and threshold to exceed) as well as in terms of the Random Access (RA) preamble to be sent when a condition is met.

While the UE evaluates the condition, it continues operating per its current RRC configuration, i.e., without applying the conditional HO command. When the UE determines that the condition is fulfilled, it disconnects from the serving cell, applies the conditional HO command and connects to the target cell. These steps are equivalent to the legacy handover execution.

When the UE has successfully performed the random access procedure towards the target cell during a conditional handover or a normal handover, it then releases all the conditional reconfigurations that it has stored. The target cell may then configure new conditional reconfigurations to the UE if it is considered useful.

### Conditional PSCell Change (CPC) in 3GPP Rel-16

A solution for Conditional PSCell Change (CPC) procedure was also standardized in Rel-16. Therein a UE operating in Multi-Radio Dual Connectivity (MR-DC) receives in a conditional reconfiguration one or multiple RRC Reconfiguration(s) (e.g. an RRCReconfiguration message) containing an SCG configuration (e.g. an secondaryCellGroup of information element (IE) CellGroupConfig) a with reconfigurationWithSync that is stored and associated to an execution condition (e.g. a condition like an A3/A5 event configuration), so that one of the stored messages is only applied upon the fulfillment of the execution condition e.g. associated with the serving PSCell, upon which the UE would perform PSCell change (in case it finds a neighbour cell that is better than the current SpCell of the SCG). Only intra-SN CPC without MN involvement is standardized in 3GPP Rel-16, i.e. for cases where the (candidate) target PSCells are located in the current serving SN.

Similar to conditional handover, in case a random access was performed for a target PSCell and the UE was configured with CPC, the UE then releases all the conditional reconfigurations that it has stored.

### CPA and Inter-SN CPC in 3GPP Rel-17

In 3GPP Rel-17 solutions for Conditional PSCell Addition (CPA) and inter-SN CPC are being discussed and introduced. The CPA procedure is used for adding a PSCell/SCG to the configuration for a UE that is currently only configured with an MCG, when associated execution conditions are fulfilled. CPA is initiated by the MN by requesting an SCG configuration, which is to be provided as part of a conditional reconfiguration to the UE, from a (candidate) target SN (T-SN), and then sending it in a conditional reconfiguration to the UE together with the associated execution conditions.

The inter-SN CPC can be initiated either by the MN or by the source SN (S-SN), where the signalling towards the source SN and the (candidate) target SNs, as well as towards the UE, in both cases is handled by the MN. One of the possible signalling sequences for configuration of an inter-SN CPC, which is initiated by the source SN, in 3GPP Rel-17 can be seen in the signaling flow in FIG. 5.

Also for Rel-17 Conditional PSCell change (CPC)/Conditional PSCell addition (CPA), it can be expected that the UE configured with CPC/CPA has to release the CPC/CPA configurations when completing random access towards the target PSCell.

### UE Variables for Conditional Reconfigurations

When the UE is configured with a conditional reconfiguration it stores the received configuration. received configuration. In 3GPP TS 38.331, v17.2.0, a UE variable VarConditionalReconfig is defined for storing of the conditional reconfigurations. The VarConditionalReconfig consists of condReconfigList, which is defined as a list of conditional reconfigurations using the Information Element CondReconfigToAddModList.

The UE variable VarConditionalReconfig includes the accumulated configuration of the conditional handover, conditional PSCell addition or conditional PSCell change configurations including the pointers to conditional handover, conditional PSCell addition or conditional PSCell change execution condition (associated measId(s)) and the stored target candidate SpCell RRCReconfiguration.

VarConditionalReconfig UE variable

-- ASN1START
-- TAG-VAPCONDITIONALRECONFIG-START

| | |
|---|---|
| VarConditional Reconfig :: = | SEQUENCE { |
| condReconfigList | CondReconfigToAddModList-r16 |

OPTIONAL
}
-- TAG-VARCONDITIONALRECONFIG-STOP
-- ASN1STOP

The IE CondReconfigToAddModList concerns a list of conditional reconfigurations to add or modify, with for each entry the condReconfigId and the associated condExecutionCond/condExecutionCondSCG and condRRCReconfig.

CondReconfigToAddModList information element

-- ASN1START
-- TAG-CONDRECONFIGTOADDMODLIST-START

| | |
|---|---|
| CondReconfigToAddModList-r16 ::= | SEQUENCE (SIZE (1.. maxNrofCondCells-r16)) |

OF CondReconfigToAddMod-r16

| | |
|---|---|
| CondReconfigToAddMod-r16 ::= | SEQUENCE { |
| condReconfigId-r16 | CondReconfigId-r16, |
| condExecutionCond-r16 | SEQUENCE (SIZE (1..2)) OF MeasId |

OPTIONAL, -- Need M

| | |
|---|---|
| condRRCReconfig-r16 | OCTET STRING (CONTAINING |

| | | |
|---|---|---|
| RRCReconfiguration) | OPTIONAL, | -- Cond condReconfigAdd |

```
  ...,
  [[
```

| | |
|---|---|
| condExecutionCondSCG-r17 | OCTET STRING (CONTAINING |

| | | |
|---|---|---|
| CondReconfigExecCondSCG-r17) | OPTIONAL | -- Need M |

]]
}

| | |
|---|---|
| CondReconfigExecCondSCG-r17 :: = | SEQUENCE (SIZE (1..2)) OF MeasId |

-- TAG-CONDRECONFIGTOADDMODLIST-STOP
-- ASN1STOP

Since the conditional reconfigurations can be generated either by the SN (for Rel-16 intra-SN CPC) or by the MN (for CHO or for Rel-17 inter SN CPC) the conditional reconfigurations are stored by the UE in different VarConditionalReconfig variables depending on whether they are generated by the SN or by the MN, in an SCG VarConditionalReconfig or an MCG VarConditionalReconfig, respectively. This way there is e.g. no need to coordinate the identities of the conditional reconfigurations (condReconfigId-r16) between the MN and the SN.

NR-DC with selective activation of the cell groups (at least for SCG) via L3 enhancements in 3GPP Rel-18

For 3GPP Rel-18 work is starting up to introduce enhancements for different mobility procedures, with a Work Item Description in RP-221799, Revised WID on Further NR mobility enhancements, MediaTek, 3GPP TSG RAN Meeting #96e, Jun. 6-9, 2022. One of the current objectives is “to specify mechanism and procedures of NR-DC with selective activation of the cell groups (at least for SCG) via L3 enhancements”, which includes “to allow subsequent cell group change after changing CG without reconfiguration and re-initiation of CPC/CPA”.

It should thus be possible to perform a subsequent cell group change after a first cell group change, without reconfiguring or re-initiation Conditional PSCell Change (CPC) or Conditional PSCell Addition (CPA). This would then be done in order to reduce the interruption time and the signalling overhead for SCG changes, especially in the case of frequent SCG changes when operating in FR2 in NR, compared to when these configurations are released when the UE completes random access towards the target PSCell, as in the previous releases.

At the 3GPP RAN2 #119bis-e meeting the following was agreed as baseline procedure for the NR-DC with selective activation:
Baseline procedure to support subsequent secondary cell group change (FFS if UE keeps all configurations or if those are indicated by the network, FFS support of nested configs):
a. Step 1: when the execution condition of a CPC candidate PScell is met, a UE performs the execution of CPC towards this candidate PScell.
b. Step 2: After finishing the PSCell addition or change, the UE doesn't release conditional configuration of other candidate PSCells for subsequent CPC, the UE continues evaluating the execution conditions of other candidate PScells.
c. Step 3: When the execution condition of a candidate PScell is met, the UE performs the execution of CPC towards this candidate PSCell.

Compared to the handling of conditional reconfigurations (e.g. CPC configurations) in Rel-17, the difference is that the UE then keeps, i.e. does not release, other CPC configurations when the UE performs e.g. a PSCell change. That way the UE can perform a subsequent PSCell change based on one of those kept CPC configurations.

### SUMMARY

There currently exist certain challenge(s). For example, The UE may be configured with Conditional PSCell Change (CPC) configurations for both intra-SN CPC candidate PSCells, using the Rel-16 intra-SN CPC solution, and for inter-SN CPC candidate PSCells, using the Rel-17 SN initiated inter-SN CPC solution or the Rel-17 MN initiated inter-SN CPC solution. By allowing that the UE keeps a CPC configuration when it performs a PSCell change to another SN, a stored intra-SN CPC configuration may then after the PSCell change include a candidate target PSCell in another SN whereas an inter-SN CPC configuration may include a candidate target PSCell that is located in the serving SN. The latter is due to that the UE may have been configured with more than one inter-SN CPC configuration with a candidate target PSCell in the same candidate target SN.

It is then unclear how such a CPC configuration, i.e. an intra-SN CPC configuration with the candidate target PSCell belonging to another SN or an inter-SN CPC configuration with the candidate target PSCell belonging to serving SN, should be handled.

If it is not possible to store the corresponding CPC configurations at an inter-SN PSCell change, an issue is that there would be a need to reconfigure the corresponding CPC configuration after the PSCell change and the benefits of the Rel-18 feature could not be achieved at inter-SN PSCell changes.

Certain aspects of the disclosure and their embodiments may provide solutions to these or other challenges.

According to a first aspect, there is provided a method performed by a UE operating in Dual Connectivity with a MN and a serving SN. The method comprises receiving, from the MN, a CPC configuration for a first candidate target PSCell of the serving SN, where the CPC configuration is in MN format.

According to a second aspect, there is provided a method performed by a first network node operating as an MN for a UE. The UE is operating in Dual Connectivity with the MN and a serving SN. The method comprises sending, to the UE, a conditional PSCell change configuration for a first candidate target PSCell of the serving SN, where the CPC configuration is in MN format.

According to a third aspect, there is provided a method performed by a second network node operating as a serving SN for a UE that is operating in Dual Connectivity with a MN and the serving SN. The method comprises sending, to the MN, a third indication to configure the UE with a CPC configuration for a first candidate target PSCell of the serving SN, where the CPC configuration is in MN format.

According to a fourth aspect, there is provided a UE adapted to perform the method according to any embodiment of the first aspect.

According to a fifth aspect, there is provided a UE comprising a processor and a memory. Said memory contains instructions executable by said processor whereby said UE is operative to operate in DC with a MN and a serving SN. The UE is further operative to receive, from the MN, a CPC configuration for a first candidate target PSCell of the serving SN, where the CPC configuration is in MN format.

According to a sixth aspect, there is provided a first network node adapted to perform the method according to any embodiment of the second aspect.

According to a seventh aspect, there is provided a first network node comprising a processor and a memory, said memory containing instructions executable by said processor whereby said first network node is operative to operate as a MN for a UE operating in Dual Connectivity with the MN and a serving SN. The first network node is further operative to send, to the UE, a CPC configuration for a first candidate target PSCell of the serving SN, where the CPC configuration is in MN format.

According to an eighth aspect, there is provided a second network node adapted to perform the method according to any embodiment of the third aspect.

According to a ninth aspect, there is provided a second network node comprising a processor and a memory, said memory containing instructions executable by said processor whereby said second network node is operative to operate as a serving SN for a UE operating in Dual Connectivity with a MN and the serving SN. The second network node is further operative to send, to the MN, a third indication to configure the UE with a CPC configuration for a first candidate target PSCell of the serving SN, where the CPC configuration is in MN format.

According to a tenth aspect, there is provided a computer program product comprising a computer readable medium having computer readable code embodied therein, the computer readable code being configured such that, on execution by a suitable computer or processor, the computer or processor is caused to perform the method of any of first, second or third aspect.

Thus, examples of this disclosure may provide different methods for handling of CPC configurations for NR-DC with selective activation, i.e. where the CPC configuration can be stored at cell changes, when the UE performs an inter-SN (PSCell) change that leads to that the candidate target PSCell of an intra-SN CPC configuration belongs to another SN or that the candidate target PSCell of an inter-SN CPC configuration belongs to the serving SN.

For example, a method according to this disclosure may include one or more of the following:
Configuration of intra-SN CPC (for NR-DC with selective activation) is supported using the MN format, i.e. that the MN is involved in the configuration.
An intra-SN CPC configuration is converted into an inter-SN CPC configuration, e.g. that a Rel-16 intra-SN CPC configuration in SN format is converted into a Rel-17 inter-SN CPC configuration in MN format.
An inter-SN CPC configuration is converted into an intra-SN CPC configuration, e.g. through one or more of the following:
   a Rel-17 SN initiated inter-SN CPC configuration in MN format is converted into a Rel-16 intra-SN CPC configuration in SN format.
   a Rel-17 MN initiated inter-SN CPC configuration in MN format is converted into a Rel-16 intra-SN CPC configuration in SN format
   a Rel-17 inter-SN CPC configuration (in MN format) is used also for a candidate target PSCell in the serving SN (i.e. for an intra-SN CPC case)
Some type(s) of CPC configurations (for NR-DC with selective activation), or some of the configurations of a certain type, is/are released or deactivated at inter-SN PSCell change, e.g. through one or more of the following:
   an intra-SN CPC configuration is released at an inter-SN PSCell change (i.e. to another SN).
   an intra-SN CPC configuration is deactivated (i.e. not used/evaluated) after the UE has performed an inter-SN PSCell change, and thus is located in another SN.
   an inter-SN CPC configuration is released or deactivated in case the UE performs (an inter-SN) PSCell change procedure to another PSCell that belongs to the same SN as the candidate target PSCell in the CPC configuration.
   In some alternatives, the network indicates to the UE what CPC configurations to release or deactivate at an inter-SN PSCell change.
The intra-SN CPC configurations are kept also at an inter-SN PSCell change, but they are not evaluated while the UE is in a PSCell that belongs to another SN
The intra-SN CPC configurations are kept also when the UE is located in another SN, but they are then not “active”, i.e. the UE does not need to evaluate the conditions for those CPC configurations in that case, or in case the UE performs evaluation it does not execute the associated configuration if the conditions are fulfilled. In case the UE moves to a cell in the same SN again, the corresponding intra-SN CPC configurations (for other candidate target PSCells) then become activated again, i.e. that the UE performs evaluation for the associated conditions and performs execution of the configuration if the conditions are fulfilled.
The intra-SN CPC configurations for an SN are included within inter-SN CPC configurations with candidate target PSCell in that SN. The intra-SN CPC configurations are then included within the SCG configuration of the corresponding inter-SN CPC configurations. When the UE then executes an inter-SN CPC configuration to the SN, it will then apply the associated SCG configuration and thereby the included intra-SN CPC configuration(s).

In some examples of this disclosure, an intra-SN CPC configuration is converted into an inter-SN CPC configuration when the UE performs an inter-SN PSCell change and that the included candidate target PSCell belongs to a different SN than the new serving PSCell.

Certain embodiments may provide one or more of the following technical advantage(s). For example, examples of this disclosure may allow a UE to keep intra-SN CPC configurations when performing an inter-SN PSCell change procedure and/or to keep an inter-SN CPC configuration when moving to a cell in the same SN as the candidate target PSCell of the CPC configuration (i.e. which then is an intra-SN candidate target PSCell). This leads to that there is no need for reconfigurations of the corresponding CPC configurations at those inter-SN PSCell changes.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 is a schematic illustrating dual connectivity combined with carrier aggregation in MR-DC;

FIG. 2 is a schematic illustrating EN-DC;

FIG. 3 is a schematic illustrating NR-DC;

FIG. 4 is a signaling diagram showing a conditional handover execution;

FIG. 5 is a signaling diagram showing a configuration of an inter-SN CPC;

FIG. 6 is a flow chart illustrating a method performed by a UE in accordance with some embodiments;

FIG. 7 is a flow chart illustrating a method performed by a first network node in accordance with some embodiments;

FIG. 8 is a flow chart illustrating a method performed by a second network node in accordance with some embodiments;

FIG. 9 is a flow chart illustrating a method in accordance with some embodiments;

FIG. 10 is a schematic illustrating a system structure according to some embodiments;

FIG. 11 is a flow chart illustrating a method in accordance with some embodiments;

FIG. 12 shows an example of a communication system in accordance with some embodiments;

FIG. 13 shows a UE in accordance with some embodiments;

FIG. 14 shows a network node in accordance with some embodiments;

FIG. 15 is a block diagram of a host;

FIG. 16 is a block diagram illustrating a virtualization environment in which functions implemented by some embodiments may be virtualized; and

FIG. 17 shows a communication diagram of a host communicating via a network node with a UE over a partially wireless connection in accordance with some embodiments.

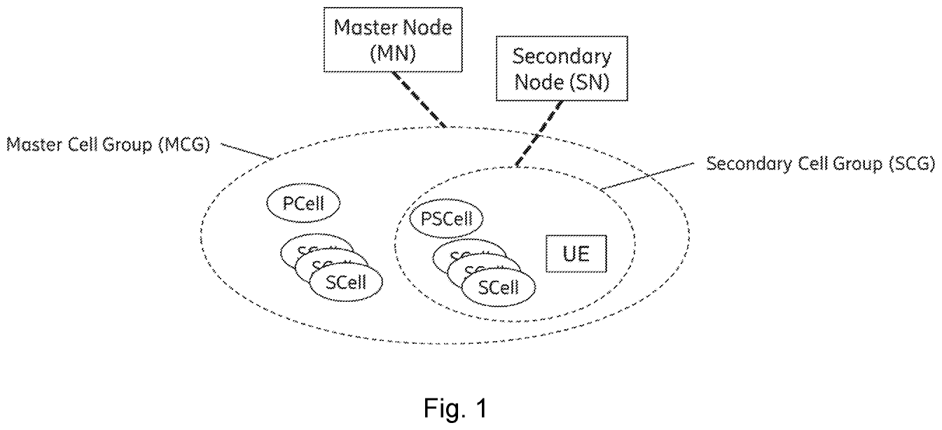

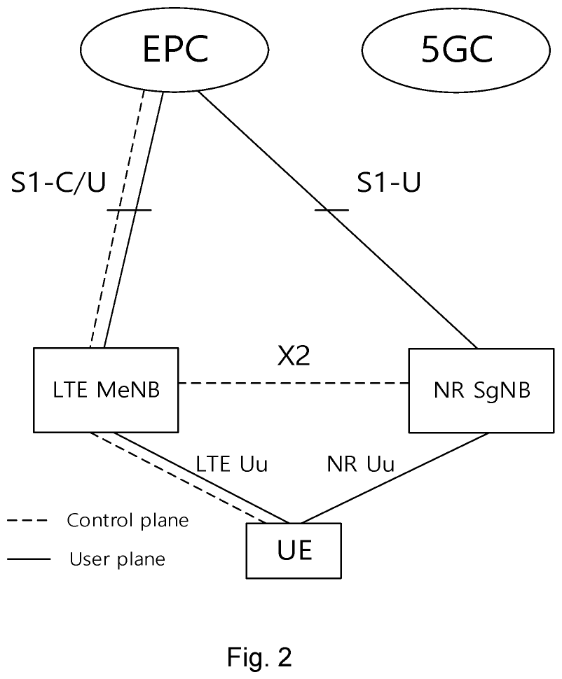

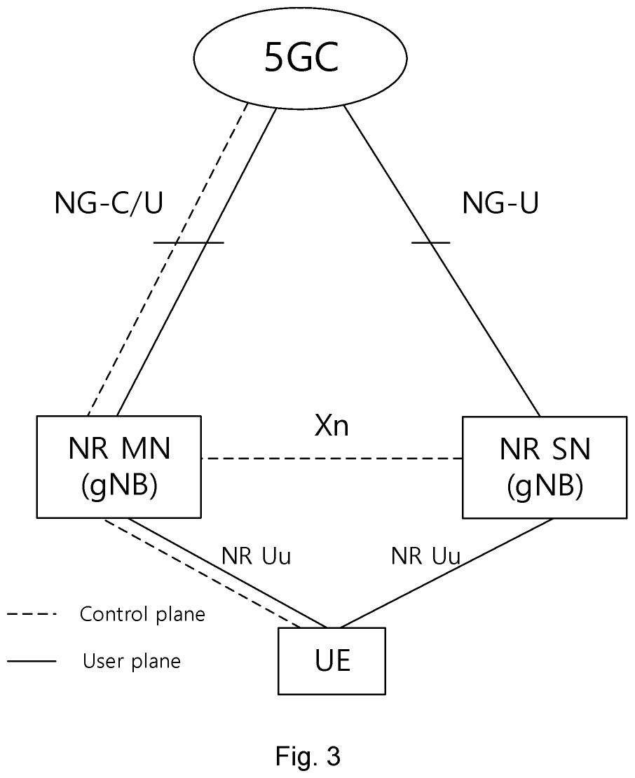

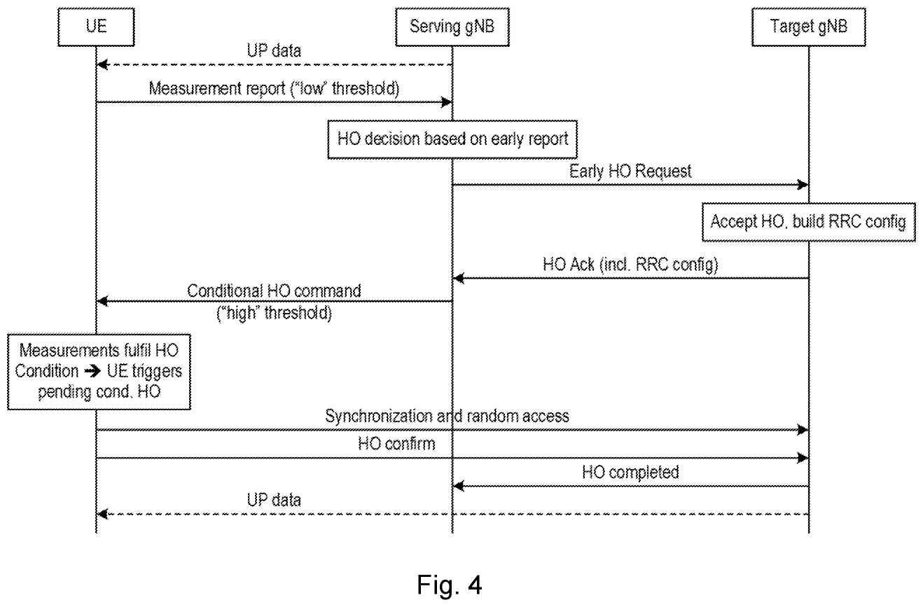

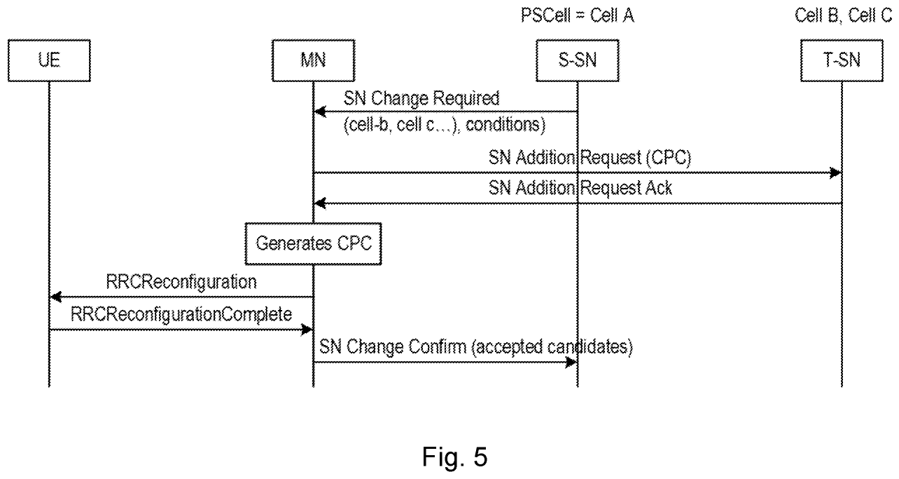

### DETAILED DESCRIPTION

Some of the embodiments contemplated herein will now be described more fully with reference to the accompanying drawings. Embodiments are provided by way of example to convey the scope of the subject matter to those skilled in the art.

This disclosure refers to a first network node operating as a Master Node (MN), e.g. having a Master Cell Group (MCG) configured to the UE; that MN can be a gNodeB, or a Central Unit gNodeB (CU-gNB) or an eNodeB, or a Central Unit eNodeB (CU-eNB), or any network node and/or network function. The invention also refers to a second network node operating as a Secondary Node (SN), or Source Secondary Node (S-SN) e.g. having a Secondary Cell Group (SCG) pre-configured (i.e. not connected to) to the UE; that SN can be a gNodeB, or a Central Unit gNodeB (CU-gNB) or an eNodeB, or a Central Unit eNodeB (CU-eNB), or any network node and/or network function. Notice that MN, S-SN and T-SN may be from the same or different Radio Access Technologies (and possibly be associated to different Core Network nodes).

This disclosure refers to a “Secondary Node (SN)”, or target SN. In some examples, it is equivalent to say this is a target candidate SN, or a network node associated to a target candidate PSCell that is being configured. If the UE would connect to that cell, transmissions and receptions with the UE would be handled by that node if the cell is associated to that node.

This disclosure indicates that a cell resides in a node e.g. a target candidate cell resides in the S-SN or the target SN (t-SN). In some examples, it is equivalent to say that a cell is controlled and/or managed by the node (SN), or is associated to the node, or associated with the node, or that the cell belongs to the node, or that the cell is of the node.

“SN-initiated CPC” corresponds to a procedure wherein the Source SN for a UE configured with MR-DC determines to configure CPC. Upon determining the Source SN selects, e.g. based on reported measurements, one or more target candidate cells (target candidate PSCell(s)). It can be said that if the target candidate cell is associated to the Source SN it is an “SN-initiated intra-SN CPC”, which may be referred as the Release-16 solution. It can be said that if the target candidate cell is associated to a neighbour SN it is an “SN-initiated inter-SN CPC”, which may be referred as a Release-17 solution.

This disclosure refers to a candidate SN, or SN candidate, or an SN, as the network node (e.g. gNodeB) that is prepared during the CPA procedure and that can create an RRC Reconfiguration message with an SCG configuration (e.g. RRCReconfiguration**) to be provided to the UE and stored, with an execution condition, wherein the UE only applies the message upon the fulfillment of the execution condition. That candidate SN is associated to one or multiple PSCell candidate cell(s) that the UE can be configured with. The UE then can execute the condition and accesses one of these candidate cells, associated to a candidate SN that becomes the SN or simply the SN after execution (i.e. upon fulfillment of the execution condition).

This disclosure refers to a Conditional PSCell Change (CPC) configuration and procedures (like CPC execution), which may refer for example to the procedure from the UE perspective. Other terms may be considered as synonyms such as conditional reconfiguration, or Conditional Configuration (since the message that is stored and applied upon fulfillment of a condition is an RRCReconfiguration or RRCConnectionReconfiguration). Terminology wise, one could also interpret conditional handover (CHO) in a broader sense, also covering CPA (Conditional PSCell Change) procedures. The document refers to a Conditional SN Change most of the time to refer to the procedure from the UE perspective, to refer to procedures between network nodes wherein a node requests a target candidate SN (which may be the same as the Source SN or a neighbour SN) to configure a conditional PSCell Change (CPC) for at least one of its associated cells (cell associated to the target candidate SN). The term CPC may in some examples however include both change of a PSCell (e.g. a serving PSCell) to another PSCell (e.g. a target PSCell), or addition of a PSCell (e.g. a target PSCell), for example where there was no serving PSCell.

This disclosure refers to CPAC (or CPC) as a way to refer to either a Conditional PSCell Addition (CPA) or a Conditional PSCell Change (CPC). In some examples, such as in the embodiments disclosed herein, the terms CPC and CPAC are used interchangeably, and CPC and CPAC may each include CPC and CPA.

This disclosure refers to a neighbour SN and a Source SN as different entities, though both could be a target candidate SN for CPC.

The configuration of CPC can be done using the same IEs as conditional handover, which may be called at some point conditional configuration or conditional reconfiguration. The principle for the configuration is the same with configuring triggering/execution condition(s) and a reconfiguration message to be applied when the triggering condition(s) are fulfilled. The configuration IEs from TS 38.331:

### ConditionalReconfiguration

The IE ConditionalReconfiguration is used to add, modify and release the configuration of conditional configuration.

ConditionalReconfiguration information element

-- ASN1START
-- TAG-CONDITIONALRECONFIGURATION-START

| | |
|---|---|
| ConditionalReconfiguration-r16 ::= | SEQUENCE { |
| attemptCcondReconfig-r16 | ENUMERATED {true} |

OPTIONAL, -- Need N

| | |
|---|---|
| condConfigToRemoveList-r16 | CondConfigToRemoveList-r16 |

OPTIONAL, -- Need N

| | |
|---|---|
| condConfigToAddModList-r16 | CondConfigToAddModList-r16 |

OPTIONAL, -- Need N
...
}

| | |
|---|---|
| CondConfigToRemoveList-r16 ::= | SEQUENCE (SIZE (1.. |

maxNrofCondCells)) OF CondConfigId-r16
-- TAG-CONDITIONALRECONFIGURATION-STOP
-- ASN1STOP

ConditionalReconfiguration field descriptions

condConfigToAddModList
List of the configuration of candidate SpCells to be added or modified for CHO or CPC.
condConfigToRemoveList
List of the configuration of candidate SpCells to be removed. When the network removes
the stored conditional configuration for a candidate cell, the network releases the measIDs
associated to the condExecutionCond if it is not used by the condExecutionCond of other
candidate cells.

CondConfigId

The IE CondConfigId is used to identify a CHO or CPC configuration.

CondConfigId information element

-- ASN1START
-- TAG-CONDCONFIGID-START
CondConfigId-r16 ::= INTEGER (1.. maxNrofCond-Cells)
-- TAG-CONDCONFIGID-STOP
-- ASN1STOP

CondConfigToAddModList

The IE CHO-ConfigToAddModList concerns a list of conditional configurations to add or modify, with for each entry the cho-Configld and the associated condExecutionCond and condRRCReconfig.

CondConfigToAddModList information element

-- ASN1START
-- TAG-CONDCONFIGTOADDMODLIST-START

| | |
|---|---|
| CondConfigToAddModList-r16 :: = | SEQUENCE (SIZE (1.. |

maxNrofCondCells)) OF CondConfigToAddMod-r16

| CondConfigToAddMod-r16 ::= | | SEQUENCE { |
|---|---|---|
| condConfigId-r16 | | CondConfigId-r16, |
| condExecutionCond-r16 | | SEQUENCE (SIZE |
| (1..2)) OF MeasId OPTIONAL, | -- Need S | |
| condRRCReconfig-r16 | | OCTET STRING |
| (CONTAINING RRCReconfiguration) | OPTIONAL, | -- Need S |

...
}
-- TAG-CONDCONFIGTOADDMODLIST-STOP
-- ASN1STOP

CondConfigToAddMod field descriptions

condExecutionCond
The execution condition that needs to be fulfilled in order to trigger the execution of a
conditional configuration. The field is mandatory present when a condConfigId is being
added. Otherwise, when the condRRCReconfig associated to a condConfigId is being
modified it is optionally present and the UE uses the stored value if the field is absent.
condRRCReconfig
The RRCReconfiguration message to be applied when the condition(s) are fulfilled. The
field is mandatory present when a condConfigId is being added. Otherwise, when the
condExecutionCond associated to a condConfigId is being modified it is optionally present
and the UE uses the stored value if the field is absent.

In some embodiments, these IEs are used differently e.g. sometimes generated by the MN, sometimes generated by the source SN, sometimes by a target candidate SN.

In some embodiments, it is said the CPC is in MN format when the CPC configuration is not configured as an MR-DC configuration in mrdc-SecondaryCellGroup (as defined in TS 38.331 version 17.2.0: “For NR-DC (nr-SCG), mrdc-SecondaryCellGroup contains the RRCReconfiguration message as generated (entirely) by SN gNB”). In other words, the UE receives an RRCReconfiguration from the MN that may contain the mrdc-SecondaryCellGroup (e.g. in case the UE is also configured with an SCG MeasConfig for inter-SN CPC) but the CPC is not within that container. That means the IEs listed above (e.g. the IE ConditionalReconfiguration) are not included in mrdc-SecondaryCellGroup.

In some embodiments, it is said the CPC is in SN format when the CPC configuration is configured as an MR-DC configuration in mrdc-SecondaryCellGroup (as defined in TS 38.331). In other words, the UE receives an RRCReconfiguration from the MN that may contain the mrdc-SecondaryCellGroup and the CPC is within that container. That means the IEs listed above (e.g. the IE ConditionalReconfiguration) are included in mrdc-SecondaryCellGroup (e.g. within a series of other nested IEs).

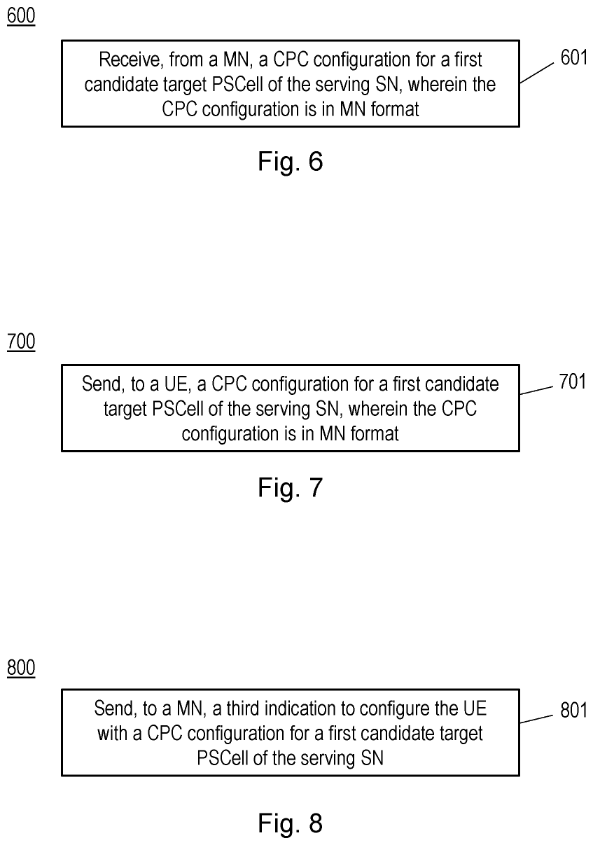

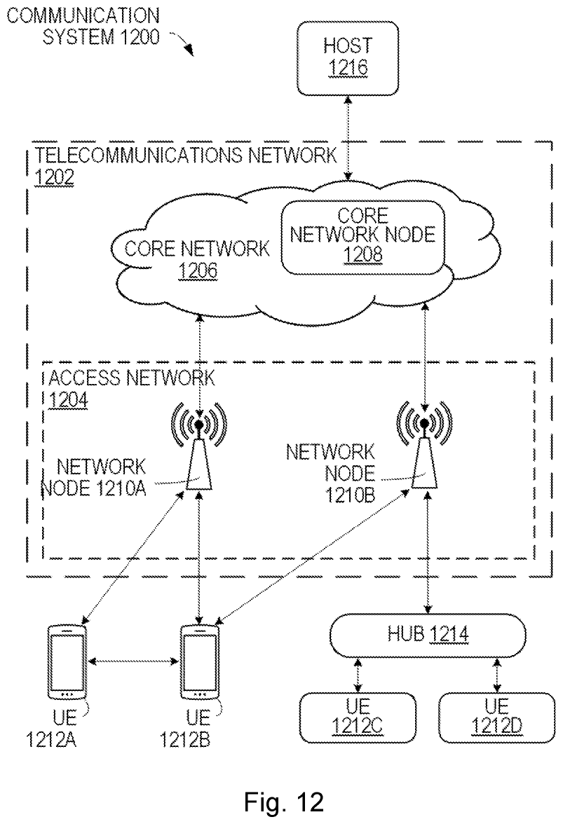

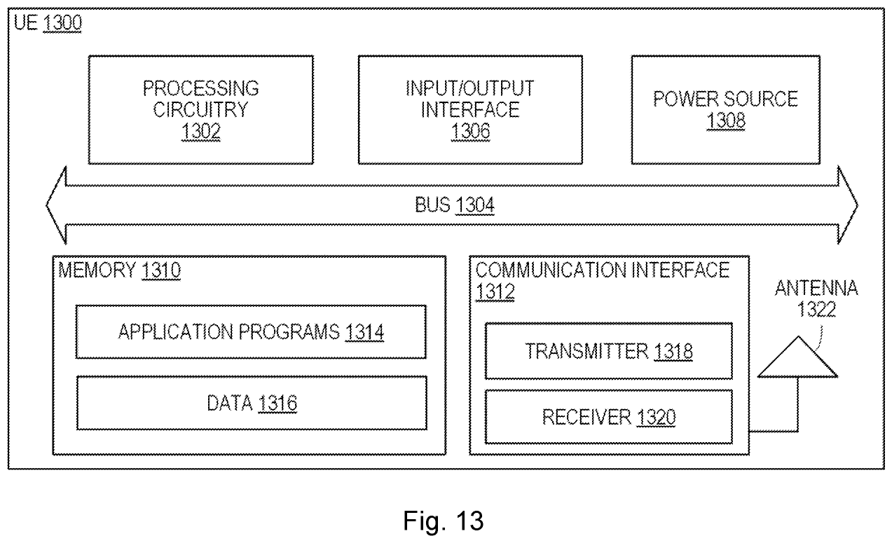

FIG. 6 is a flow chart illustrating a method 600 performed by a UE in accordance with some embodiments. The method 600 may be performed by a UE or wireless device (e.g. the UE 1212 or UE 1300 as described with reference to FIGS. 12 and 13 respectively). The UE is operating in Dual Connectivity (e.g., NR-DC) with a MN and a serving SN.

The method 600 comprises, at step 601, receiving, from the MN, a CPC configuration for a first candidate target PSCell of the serving SN. The CPC configuration is in MN format. MN format may indicate that the CPC configuration is generated with MN involvement, i.e., the MN is involved in the configuration. For example, MN format may mean that the CPC configuration is configured with fields/procedures that include MN involvement (i.e., the CPC configuration is comprised in a field that is generated by the MN not the SN). For example, receiving the CPC configuration in MN format may comprise receiving an RRCReconfiguration message in which the CPC configuration is provided in a field that is generated with MN involvement, e.g., the MCG part of the configuration (not in the SCG part of the configuration such as mrdc-SecondaryCellGroup).

Receiving the CPC configuration for the first candidate target PSCell may comprise receiving an RRCReconfiguration message in which the CPC configuration for the first candidate target PSCell is comprised in a field other than mrdc-SecondaryCellGroup. The field comprising the CPC configuration for the first candidate target PSCell may be generated with MN involvement.

The CPC configuration for the first candidate target PSCell may be received together with one or more associated execution conditions for the CPC configuration for the first candidate target PSCell. The CPC configuration for the first candidate target PSCell may be received with a first indication that the CPC configuration for the first candidate target PSCell can be kept at a cell change procedure. The CPC configuration for the first candidate target PSCell may be received with a first identifier for the serving SN to which the first candidate target PSCell belongs.

The method 600 may further comprise storing the CPC configuration for the first candidate target PSCell in an MCG VarConditionalReconfig UE variable.

The method 600 may further comprise receiving, from the MN, a CPC configuration for a second candidate target PSCell of a different SN to the serving SN, where the CPC configuration for the second candidate target PSCell is in MN format. Thus, the CPC configuration for the second candidate target PSCell is in the same format as the CPC configuration for a first candidate target PSCell.

The method 600 may further comprise storing the CPC configuration for the second candidate target PSCell in an MCG VarConditionalReconfig UE variable.

The method 600 may further comprise, after receiving the CPC configuration for the first candidate target PSCell and the CPC configuration for the second candidate target PSCell, executing an inter-SN CPC to the second candidate target PSCell. The method 600 may further comprise, after executing the inter-SN CPC to the second candidate PSCell, keeping the received CPC configuration for the first candidate PSCell. Thus, an intra-SN CPC may be kept after an inter-SN PSCell change away from the SN (now as a configuration for inter-SN CPC). This is possible because both inter-SN CPC and intra-SN CPC configurations are received and stored in MN format. The method 600 may comprise, after executing the inter-SN CPC to the second candidate target PSCell, evaluating an execution condition associated with the received CPC configuration for the first candidate PSCell.

The method 600 may comprise, after receiving the CPC configuration for the second candidate target PSCell, executing an inter-SN CPC to a third candidate target PSCell. The method 600 may comprise, after executing the inter-SN CPC to the third candidate PSCell, keeping the received CPC configuration for the second candidate PSCell. Thus, an inter-SN CPC configuration may be kept after an inter-SN PSCell change in which the target PSCell of said inter-SN CPC becomes an intra-SN PSCell candidate (thus, the configuration is now a configuration for intra-SN CPC). This is possible because both inter-SN CPC and intra-SN CPC configurations are received and stored in MN format. The method 600 may comprise, after executing the inter-SN CPC to the third candidate target PSCell, evaluating an execution condition associated with the received CPC configuration for the second candidate PSCell.

The CPC configuration for the second candidate target PSCell may be received with a second identifier for the SN to which the second candidate target PSCell belongs. The method 600 may comprise determining, based on the first identifier and the second identifier, that the first candidate target PSCell and the second candidate target PSCell belong to different SNs.

The method 600 may comprise receiving a second indication that a plurality of CPC configurations are for candidate target PSCells that belong to the same SN as each other. The plurality of CPC configurations may comprise the CPC configuration for the first candidate target PSCell. The same SN may be the serving SN. The second indication may be received from a network node, e.g., one of the MN, the serving SN, and a candidate target SN.

The serving SN may control a SCG. The method 600 may comprise after receiving the CPC configuration for the first candidate target PSCell, releasing the SCG controlled by the serving SN. The method 600 may further comprise, after releasing the SCG, keeping the received CPC configuration for the first candidate target PSCell. The method 600 may further comprise, after releasing the SCG, evaluating an execution condition associated with the received CPC configuration for the first candidate target PSCell.

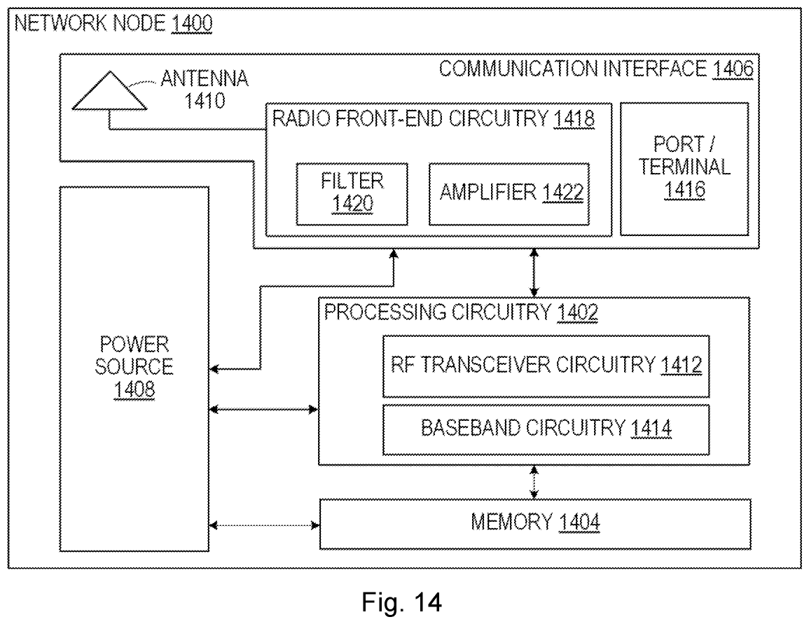

FIG. 7 is a flow chart illustrating a method 700 performed by a first network node in accordance with some embodiments. The method 700 may be performed by a network node (e.g. the network node 1210A, 1210B or 1400 as described with reference to FIGS. 12 and 14). The first network node is operating as an MN for a UE. The UE is operating in Dual Connectivity (e.g., NR-DC) with the MN and a serving SN.

The method 700 comprises, at step 701, sending, to the UE, a CPC configuration for a first candidate target PSCell of the serving SN. The CPC configuration is in MN format. MN format may indicate that the CPC configuration is generated with MN involvement, i.e., the MN is involved in the configuration. For example, MN format may mean that the CPC configuration is configured with fields/procedures that include MN involvement (i.e., the CPC configuration is comprised in a field that is generated by the MN not the SN). For example, sending the CPC configuration in MN format may comprise sending an RRCReconfiguration message in which the CPC configuration is provided in a field that is generated with MN involvement, e.g., the MCG part of the configuration (not in the SCG part of the configuration such as mrdc-SecondaryCellGroup).

Sending the CPC configuration for the first candidate target PSCell may comprise sending an RRCReconfiguration message in which the CPC configuration for the first candidate target PSCell is comprised in a field other than mrdc-SecondaryCellGroup. The field comprising the CPC configuration for the first candidate target PSCell may be generated with MN involvement (i.e., by the MN).

The CPC configuration for the first candidate target PSCell may be sent together with one or more associated execution conditions for the CPC configuration for the first candidate target PSCell. The CPC configuration for the first candidate target PSCell may be sent with a first indication that the CPC configuration for the first candidate target PSCell can be kept at a cell change procedure. The CPC configuration for the first candidate target PSCell may be sent with a first identifier for the serving SN to which the first candidate target PSCell belongs.

The method 700 may further comprise, prior to sending the CPC configuration for the first candidate target PSCell, receiving, from the serving SN, a third indication to configure the UE with the CPC configuration for the first candidate target PSCell. Receiving the third indication may comprise receiving a 3GPP XnAP S-NODE CHANGE REQUIRED message with a Target S-NG-RAN node ID for the CPC configuration set to a value for the serving SN. Receiving the third indication may comprise, receiving, from the serving SN, an indication that the CPC configuration can be kept at a cell change procedure. Receiving the third indication may comprise receiving, from the serving SN, a first identifier for the serving SN to which the first candidate target PSCell belongs.

The method 700 may further comprise sending, to the UE, a CPC configuration for a second candidate target PSCell of a different SN to the serving SN, where the CPC configuration for the second candidate target PSCell is in MN format. The CPC configuration for the second candidate target PSCell may be sent with a second identifier for the SN to which the second candidate target PSCell belongs.

The method 700 may further comprise sending, to the UE, a second indication that a plurality of CPC configurations are for candidate target PSCells that belong to the same SN as each other. The plurality of CPC configurations may comprise the CPC configuration for the first candidate target PSCell, where the same SN is the serving SN.

FIG. 8 is a flow chart illustrating a method 800 performed by a second network node in accordance with some embodiments. The method 800 may be performed by a network node (e.g. the network node 1210A, 1210B or 1400 as described with reference to FIGS. 12 and 14). The second network node is operating as a serving SN for a UE. The UE is operating in Dual Connectivity (e.g., NR-DC) with an MN and the serving SN.

The method 800 comprises, at step 801, sending, to the MN, a third indication to configure the UE with a CPC configuration for a first candidate target PSCell of the serving SN, where the CPC configuration is in MN format. MN format may indicate that the CPC configuration is to be generated with MN involvement, i.e., with the MN involved in the configuration. For example, MN format may mean that the CPC configuration is configured with fields/procedures that include MN involvement (i.e., the CPC configuration is comprised in a field that is generated by the MN not the SN). For example, a CPC configuration in MN format may mean that the CPC configuration is provided in a field that is generated with MN involvement, e.g., the MCG part of the configuration (not in the SCG part of the configuration such as mrdc-SecondaryCellGroup).

Sending the third indication may comprise sending, to the MN, an indication that the CPC configuration can be kept at a cell change procedure. Sending the third indication may comprise sending, to the MN, a first identifier for the serving SN to which the first candidate target PSCell belongs.

Sending the third indication may comprise sending a 3GPP XnAP S-NODE CHANGE REQUIRED message with a Target S-NG-RAN node ID for the CPC configuration set to a value for the serving SN.

The method 800 may further comprise sending, to the UE, a second indication that a plurality of CPC configurations are for candidate target PSCells that belong to the same SN as each other. The plurality of CPC configurations may comprise the CPC configuration for the first candidate target PSCell, where the same SN is the serving SN.

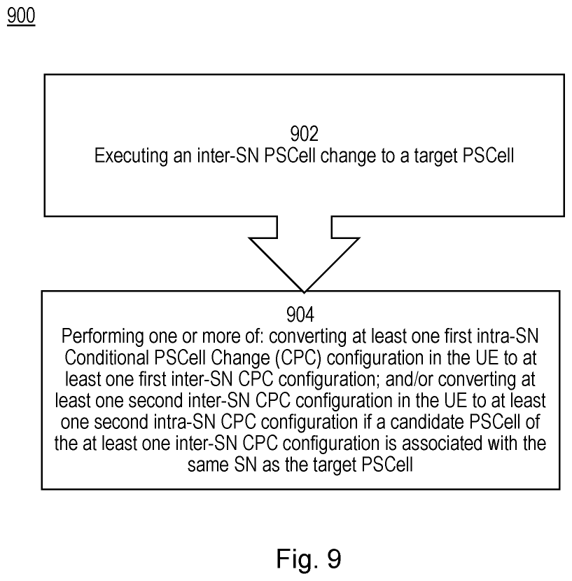

FIG. 9 depicts a method in accordance with particular embodiments, such as for example a method performed by a User Equipment (UE) for executing an inter-secondary node (SN) Primary SCell (PSCell) change. The method 900 may be performed by a UE or wireless device (e.g. the UE 1212 or UE 1300 as described later with reference to FIGS. 12 and 13 respectively). The method begins at step 902 with executing an inter-SN PSCell change to a target PSCell, and step 904 with performing one or more of: converting at least one first intra-SN Conditional PSCell Change (CPC) configuration in the UE to at least one first inter-SN CPC configuration; and/or converting at least one second inter-SN CPC configuration in the UE to at least one second intra-SN CPC configuration if a candidate PSCell of the at least one inter-SN CPC configuration is associated with the same SN as the target PSCell.

Additional example embodiments, which may in some examples be examples of the above general concepts, are now described.

### Conversion Between Intra-SN and Inter-SN CPC Configurations

In the 3GPP Rel-18 work with “NR-DC with selective activation” a solution is that the UE can be configured with one or more Conditional PSCell Change (CPC) configurations, which can be kept (i.e. not released) when the UE performs a cell change procedure, e.g. when it performs a PSCell change procedure (i.e. a normal PSCell change procedure or execution of a CPC procedure). The CPC configurations could be either intra-SN CPC (i.e. for a candidate target PSCell in the same SN) or inter-SN CPC (i.e. for a candidate target PSCell in another SN). After performing an inter-SN PSCell change, a CPC configuration that was an intra-SN CPC before the change would then correspond to an inter-SN CPC after the cell change, whereas an inter-SN CPC may correspond to an intra-SN CPC after the cell change in case the cell change was to another PSCell in the same SN as the candidate target PSCell in the CPC configuration. This disclosure provides examples of different solutions to handle these cases.

In one example embodiment a User Equipment (UE) converts an intra-SN CPC configuration (e.g. a Rel-16 intra-SN CPC configuration in SN format) into an inter-SN CPC configuration (e.g. a Rel-17 inter-SN CPC configuration in MN format) when it performs a PSCell change procedure, e.g. an inter-SN PSCell change procedure.

In one alternative example embodiment, the conversion of an intra-SN CPC configuration into an inter-SN CPC configuration consists of that the UE considers the configuration to be an inter-SN CPC configuration, such as e.g. an SN-initiated inter-SN CPC configuration or an MN-initiated inter-SN CPC configuration, in the different procedures, such as the CPC execution procedure. In one example this corresponds to that e.g. the UE, at completion of the CPC execution procedure, sends an RRCReconfiguration Complete message to the MN (RRCReconfigurationComplete*), including an RRCReconfigurationComplete message to the SN for the selected candidate PSCell (RRCReconfiguration Complete**). In one example the RRCReconfigurationComplete message to the MN then also includes information to enable the MN to identify the SN of the selected candidate PSCell. In one example, this information consists of an identity that identifies the SN, e.g. an SN identity. This can e.g. be an identity to identify the SN, which is included within, or associated with, the CPC configuration.

In one example where the conversion corresponds to that the intra-SN CPC configuration is considered as an MN-initiated inter-SN CPC configuration the UE stores the CPC configuration in the MCG VarConditionalReconfig (according to 3GPP TS 38.331, v17.2.0).

In one example where the conversion corresponds to that the intra-SN CPC configuration is considered as an SN-initiated inter-SN CPC configuration the UE stores the CPC configuration in the MCG VarConditionalReconfig (according to 3GPP TS 38.331, v17.2.0).

In one alternative example the UE informs the new serving SN about the intra-SN CPC configurations that it has stored and that it keeps, or can keep, at the PSCell change to the new serving SN. In one example, the information is included in a message that is sent to the target SN (i.e. the new serving SN after the PSCell change procedure). In one example, the UE sends the information to the MN. In one example, the MN then sends the information on to the target SN. In one example, the information about these stored and/or kept intra-SN CPC configurations are sent to the network in an RRC Reconfiguration Complete message that the UE sends to the network as part of executing the PSCell change procedure. In one example, the UE then also provides information about the candidate target PSCells and/or execution conditions for the intra-SN CPC configurations.

In another alternative example, the SN that configured the intra-SN CPC configurations informs the MN and/or the other SN (e.g. the target SN of a PSCell change procedure) about the intra-SN CPC configurations that it has configured the UE with. In one example, the SN that configured the intra-SN CPC configurations then also provides information about the candidate target PSCells and/or execution conditions for the intra-SN CPC configurations.

In another example embodiment the User Equipment (UE) converts an inter-SN CPC configuration (e.g. a Rel-17 inter-SN CPC configuration in MN format) into an intra-SN CPC configuration (e.g. a Rel-16 intra-SN CPC configuration in SN format) when it performs a PSCell change procedure, e.g. an inter-SN PSCell change procedure. In one example, the conversion is done when the UE performs a PSCell change procedure to the SN where the candidate target PSCell of the inter-SN CPC configuration belongs to the new serving SN.

In one alternative example, the conversion of an inter-SN CPC configuration into an intra-SN CPC configuration consists of that the UE considers the configuration to be an intra-SN CPC configuration in different procedures, such as the CPC execution procedure, e.g. that the UE at completion execution CPC procedure sends an of the ULInformation TransferMRDC to the MN, including an embedded RRCReconfigurationComplete message to the selected target PSCell, if SRB3 is not configured, or sends an RRCReconfigurationComplete message directly to the new PSCell, if SRB3 is configured.

In one example where the conversion corresponds to that the inter-SN CPC configuration is considered as an intra-SN CPC configuration, the UE stores the CPC configuration in the SCG VarConditionalReconfig (according to 3GPP TS 38.331, v17.2.0).

In one alternative example, an inter-SN CPC configuration (e.g. a Rel-17 inter-SN CPC configuration in MN format) that the UE has received when located in an SN, which is different from the one that the included candidate target PSCell belongs to, is used also when the UE has performed PSCell change to a cell in the SN that the included candidate target PSCell belongs. The inter-SN CPC configuration is then thus used by the UE also when the included candidate target PSCell belongs to the same SN as the current serving SN, i.e. the UE evaluates the conditions of the CPC configuration and executes the associated configuration in case the conditions are fulfilled. In one example, the CPC configuration is a Rel-17 SN-initiated inter-SN CPC configuration. In another example, the CPC configuration is a Rel-17 MN-initiated inter-SN CPC configuration.

In some alternative examples for the above embodiments and alternatives the steps are performed by the UE based on an indication from the network, e.g. from the MN, the target SN of the PSCell change procedure or from the source or target SN of the inter-SN CPC configuration or from the SN that configured intra-SN CPC. In one example the UE changes the handling of a CPC configuration in that a CPC configuration, which is configured as an intra-SN CPC, is considered as an inter-SN CPC or that CPC configuration, which is configured as an inter-SN CPC, is considered as an intra-SN CPC, based on an indication from the network. The change in handling can e.g. take place at execution of a cell change procedure, such as an inter-SN PSCell change. The change in handling can also correspond to that a CPC configuration that was configured as one type (e.g. intra-SN or inter-SN) and then changed to be considered as another type (e.g. into inter-SN or intra-SN, respectively) is changed back to the type that it was configured as. In some alternatives for the above embodiments and alternatives the UE is hard coded to perform the different steps or it performs them based on specifications.

In one option, the MN and the SN coordinates the CondReconfigIds before configuring the UE with NR-DC with selective activation, so that the same CondReconfigId is not used in the MN as in the SN or vice versa. This may be done to secure that an intra-SN CPC configuration that is converted into an inter-SN CPC configuration will not end up using the same CondReconfigId that is already used for another CPC/CPA configuration in MN format. The coordination of the CondReconfigIds may be done by XnAP message such as e.g. S-NODE MODIFICATION REQUIRED, S-NODE MODIFICATION REQUEST, S-NODE MODIFICATION REQUEST ACKNOWLEDGE or in an inter-node RRC message e.g. CG-Config, CG-ConfigInfo encapsulated within an XnAP message.

In one alternative example the UE is configured with different execution conditions and/or different measurement configurations for the same conditional reconfiguration (CPC configuration), where the different execution conditions and/or measurement configuration is/are associated to the case where the configuration is for an intra-SN candidate target PSCell and to the case where the configuration is for an inter-SN candidate target PSCell, respectively. If the candidate target PSCell that is included in the CPC configuration belongs to the same SN as the current serving PSCell, the UE then utilizes the execution conditions and/or measurement configuration that is/are associated to intra-SN CPC. If the candidate target PSCell that is included in the CPC configuration belongs to a different SN than the SN that the current serving PSCell belongs to, the UE instead utilizes the execution conditions and/or measurement configuration that is/are associated to inter-SN CPC.

In one option, the SN that the target candidate PSCell belongs to (the “target SN”), i.e. the candidate target SN sets the execution conditions and/or measurement configuration both for the case where the CPC configuration is an intra-SN CPC and for the case where it is an inter-SN CPC. In one example, that SN sends the execution conditions and/or measurement configuration to the MN. The MN can then send this information to the UE as part of the CPC configuration and/or send it to other SNs, e.g. other SNs that are configuring inter-SN CPC for the UE or the SN that is currently the serving SN for the UE. In one example, the “target SN” also sends the configuration to be applied at execution of the CPC configuration to the MN.

In another option, the SN that the target candidate PSCell belongs to only generates the execution conditions and/or measurement configuration that are associated to the case where the CPC configuration is an intra-SN CPC, whereas the execution conditions and/or measurement configuration that are associated to the case where the CPC configuration is an inter-SN CPC is/are generated by the MN or by another SN, e.g. another SN that is configuring inter-SN CPC for the UE or the SN that is currently the serving SN for the UE.

Configuration of Intra-SN CPC (for NR-DC with Selective Activation) Using MN Format

In one example embodiment, the configuration of intra-SN CPC candidates for NR-DC with selective activation, i.e. CPC configurations with candidate target PSCells in the same SN as the serving SN that can be kept by the UE at cell change procedures, are configured in MN format, i.e. with the Master Node (MN) involved in the configuration. In one example this corresponds to that the intra-SN CPC configurations for NR-DC with selective activation are configured using the fields for Rel-17 SN-initiated inter-SN CPC or Rel-17 MN-initiated inter-SN CPC.

In one example, the UE is then configured with both intra-SN CPC configuration(s), which is/are not kept if the UE performs an inter-SN PSCell change, or if the SCG configuration is released, and CPC configuration(s) with MN involvement for candidate target PSCell(s) that belong to the serving SN (e.g. using the fields for Rel-17 SN-initiated inter-SN CPC or Rel-17 MN-initiated inter-SN CPC), which is/are stored if the UE performs an inter-SN PSCell change or, possibly, if the SCG is released.

In one alternative example, the serving SN triggers an SN-initiated CPC procedure in MN format for a candidate target PSCell in the serving SN, for NR-DC with selective activation (i.e. where the CPC configuration can be kept at cell change procedures), by sending an indication to the MN. In one example, the serving SN sends an 3GPP XnAP S-NODE CHANGE REQUIRED message to the MN with the Target S-NG-RAN node ID (for the corresponding CPC configuration) set to the value for the serving SN. In one example, the message also includes an indication that the configuration is for NR-DC with selective activation (i.e. where the CPC configuration can be kept at cell change procedures).

In another alternative example, the serving SN triggers an MN-initiated CPC procedure in MN format for a candidate target PSCell in the serving SN, for NR-DC with selective activation (i.e. where the CPC configuration can be kept at cell change procedures), by sending an indication to the MN. In one example, the serving SN also includes an indication that the triggered CPC configuration is for NR-DC with selective activation (i.e. where the CPC configuration can be kept at cell change procedures) and/or information about one or more candidate target PSCell(s) for which CPC should be configured by the MN. The MN then initiates the configuration of the corresponding CPC configuration. In one example, the MN then sends an XnAP S-NODE ADDITION REQUEST message towards the serving SN to initiate the CPC configuration and/or to get the target configuration to be applied at PSCell change (CPC execution) to the candidate target PSCell from the serving SN, and then sends the CPC configuration to the UE. In another example, the serving SN provides also the configuration to be applied at PSCell change (CPC execution) to the candidate target PSCell together with the message that includes the trigger to the MN. The MN can then send the CPC configuration to the UE together with the associated execution conditions.

In one alternative example, the MN indicates to the serving SN that it should configure CPC configurations for intra-SN candidate target PSCell(s) with fields/procedures that include MN involvement, e.g. using the fields and/or procedures for SN-initiated inter-SN CPC or MN-initiated inter-SN CPC.

In one alternative example, the UE is configured with both an intra-SN CPC configuration and/or one or more inter-SN CPC configuration for the same candidate target PSCell. In one example where execution conditions are fulfilled for both an intra-SN CPC and for an inter-SN CPC configuration, the UE then prioritizes execution of the intra-SN CPC configuration. In another example, where execution conditions are fulfilled for both an intra-SN CPC and for an inter-SN CPC configuration, the UE then prioritizes execution of an inter-SN CPC configuration. In one example, the UE prioritizes evaluation of intra-SN CPC configuration, i.e. to perform evaluation of the execution conditions for the intra-SN CPC configuration. This may then e.g. correspond to that the UE only evaluates the intra-SN CPC configuration and does not perform evaluation of the inter-SN CPC configuration(s) for the same candidate target PSCell. In another example, the UE prioritizes evaluation of an inter-SN CPC configuration, i.e. to perform evaluation of the execution conditions for an inter-SN CPC configuration. This may then e.g. correspond to that the UE only evaluates the inter-SN CPC configuration and does not perform evaluation of the intra-SN CPC configuration(s) and/or other inter-SN CPC configurations for the same candidate target PSCell. In one example where the UE is configured with an intra-SN CPC configuration and/or one or more inter-SN CPC configuration for the same candidate target PSCell, it is up to UE implementation which of those configurations to perform evaluation for and/or to execute, in case execution conditions are fulfilled for more than one of those configurations at the same time.

Release or Deactivation of Intra-SN and/or Inter-SN CPC Configurations

In one example embodiment, a User Equipment (UE) releases one or some types of CPC configuration(s), and keeps one or more CPC configurations of other types, when the UE performs an inter-SN PSCell change procedure, i.e. a PSCell change procedure to a different SN. This includes one or more of the following:
Intra-SN CPC configurations are released at an inter-SN PSCell change (i.e. to another SN).
Inter-SN CPC configurations are released in case the UE performs (an inter-SN) PSCell change procedure to another PSCell that belongs to the same SN as the candidate target PSCell in the CPC configuration.
In another embodiment, a User Equipment (UE) considers one or some types of CPC configuration(s) as deactivated, and one or more CPC configurations of other types as activated, when the UE performs an inter-SN PSCell change procedure, i.e. a PSCell change procedure to a different SN. This includes one or more of the following:
Intra-SN CPC configurations are considered as deactivated (i.e. not used/evaluated) after the UE has performed an inter-SN PSCell change, and thus is located in another SN. The intra-SN CPC configurations are then kept also at an inter-SN PSCell change, but they are then not evaluated while the UE is in a PSCell that belongs to another SN, or they are evaluated but the UE does not execute the associated configuration if the conditions are fulfilled.
In case the UE later moves to a PSCell that is located in the same SN (as the candidate target PSCells of the intra-SN CPC configuration), the UE may consider the corresponding intra-SN CPC configurations as active again, i.e. the UE then performs evaluation for the associated conditions and performs execution of the configuration if the conditions are fulfilled. In one option the UE only considers the intra-SN CPC configurations as activated again if the network has indicated to the UE that it may “reactivate” the intra-SN CPC configurations.
An inter-SN CPC configuration is considered as deactivated in case the UE performs (an inter-SN) PSCell change procedure to a PSCell that belongs to the same SN as the candidate target PSCell in the CPC configuration. These inter-SN CPC configurations that are then considered as deactivated are not evaluated while the UE is in a PSCell that belongs to that SN, or they are evaluated but the UE does not execute the associated configuration if the conditions are fulfilled.
In case the UE later moves to a PSCell that is located in another SN (i.e. a different SN than the one that the candidate target PSCells of the inter-SN CPC configuration belongs to), the UE then considers the corresponding inter-SN CPC configuration as active again, i.e. the UE then performs evaluation for the associated conditions and performs execution of the configuration if the conditions are fulfilled.

In some alternative examples to the embodiments described herein, the network, e.g. the MN, the target SN of the PSCell change procedure or from the source or target SN of the inter-SN CPC configuration or from the SN that configured intra-SN CPC, indicates to the UE what types of CPC configurations to release or deactivate at an inter-SN PSCell change. In some alternative examples to the embodiments described herein, the network (such as a network node, e.g. the MN or an SN, e.g. the target SN of the PSCell change procedure, the source or target SN of an inter-SN CPC configuration, and/or the SN that configured intra-SN CPC) indicates to the UE what CPC configurations that have a candidate target PSCell that belong to the same SN. In one example, a new SN identity is included within, or associated with, the CPC configuration. In one example an indication, which is given the same value for CPC configurations that have a candidate target PSCell that belong to the same SN, is included within or associated to the CPC configurations.

In some alternative examples to the embodiments described herein, the network (such as a network node, e.g. the MN or an SN, e.g. the target SN of the PSCell change procedure, the source or target SN of an inter-SN CPC configuration, and/or the SN that configured intra-SN CPC) indicates to the UE what PSCell changes that are inter-SN, i.e. where the target PSCell belongs to a different SN than the source PSCell.

Intra-SN CPC Configurations within Inter-SN CPC Configurations

In one example embodiment, the intra-SN CPC configurations that can be kept at cell change procedures (e.g. for “NR-DC with selective activation”) are included within inter-SN CPC configurations with candidate target PSCell in that same SN. The intra-SN CPC configurations are then included within the SCG configuration that the UE applies at execution of the inter-SN CPC configuration, i.e. within the mrdc-SecondaryCellGroup that is included in the inter-SN CPC configuration. When the UE then executes an inter-SN CPC configuration to the SN, it will then apply the associated SCG configuration and thereby the included intra-SN CPC configuration(s). In one alternative, the UE keeps the different included intra-SN CPC configurations as long as the UE performs intra-SN PSCell changes procedures. In one example, the UE keeps the intra-SN CPC configurations as long as the UE performs a PSCell change procedure between the PSCells that are included as candidate target PSCell in any of the intra-SN CPC configurations. In one example, if the UE performs a PSCell change to a PSCell that is not included as candidate target PSCell in any of the intra-SN CPC configurations, it releases the intra-SN CPC configurations, or considers them as deactivated.

### Additional Network Coordination Before Configuring the UE

In one example embodiment there is additional network signaling in the preparation phase of the CPC configurations. When each node has prepared the CPC configurations, the other nodes with prepared candidates are informed of which other CPC configurations that the UE is about to be configured with. If a target candidate SN is informed in advance that the UE will have CPC candidates in other nodes, it may prepare the proper actions in advance in the RRCReconfiguration message for the target configuration. A target candidate SN may e.g. include release of previous intra-SN CPC candidates in the RRCReconfiguration message, i.e. the release will be network initiated instead of a UE autonomous action. A target candidate SN may e.g. also include new CPC configurations or update CPC configurations in the RRCReconfiguration that is applied when the first CPC is executed, as described in 6.1.4. The additional network coordination may be e.g. in a modification procedure by XnAP message such as e.g. S-NODE MODIFICATION REQUIRED, S-NODE MODIFICATION REQUEST, S-NODE MODIFICATION REQUEST ACKNOWLEDGE or in an inter-node RRC message e.g. CG-Config, CG-ConfigInfo encapsulated within an XnAP message. The network coordination also may be e.g. in a modification procedure by F1AP message such as e.g. UE CONTEXT MODIFICATION REQUIRED, UE CONTEXT MODIFICATION REQUEST, UE CONTEXT MODIFICATION REQUEST ACKNOWLEDGE or in an inter-node RRC message e.g. CG-Config, CG-ConfigInfo encapsulated within an F1AP message.

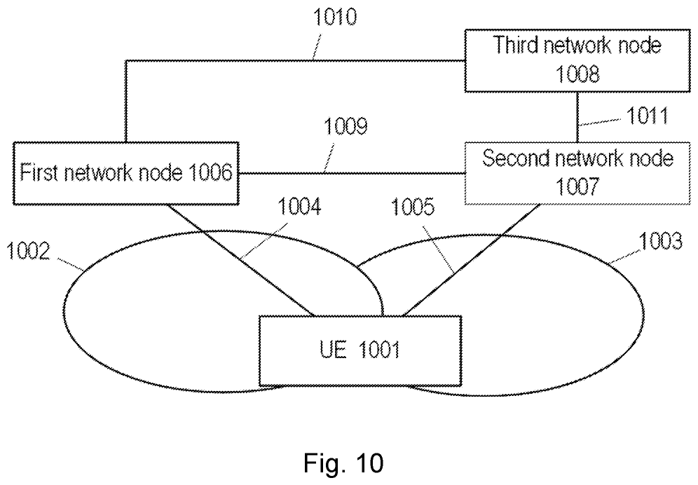

FIG. 10 is a schematic that illustrates some of the entities used in examples of this disclosure. The User Equipment, UE, 1001 is a wireless terminal, such as a cellular smartphone. The UE 1001 is sometimes configured for multi-radio dual connectivity, MR-DC.

The UE 1001 is connected via a first cell group 1002 to a first network node 1006 over a radio interface 1004. When the UE 1001 is configured in MR-DC, the UE 1001 is also connected via a second cell group 1003 to a second network node 1007 over a radio interface 1005.

The first network node 1006, sometimes known as a Master Node, MN, controls the first cell group 1002, sometimes known as the Master Cell Group, MCG. The first cell group 1002 is configured with a main cell, such as a Primary Cell, PCell, and optionally multiple additional cells, such as secondary cells, SCells, in a carrier aggregation, CA, configuration.

When the UE 1001 is configured in MR-DC, the second network node 1007, sometimes known as a Secondary Node, SN, controls the second cell group 1003, sometimes also known as the Secondary Cell Group, SCG. The second cell group 1003 is configured with a main cell, such as a Primary SCG Cell, PSCell, and optionally multiple additional cells, such as secondary cells, SCells, in a CA configuration. The second network node 1007 is connected with the first network node 1006 over an interface 1009.

The third network node 1008, is in the context of a mobility procedure or a conditional configuration sometimes also referred to as a target Secondary Node, T-SN, a target MN, T-MN, a target gNB or a target eNB. It controls a third cell group (not illustrated in FIG. 10), including a cell during a mobility procedure in the context of a mobility procedure or a conditional configuration sometimes referred to as a candidate target cell or a target cell. The third network node 1008 is connected to the first network node the first network node 1006 over an interface 1010 and may also be connected to the second network node 1007 over an interface 1011.

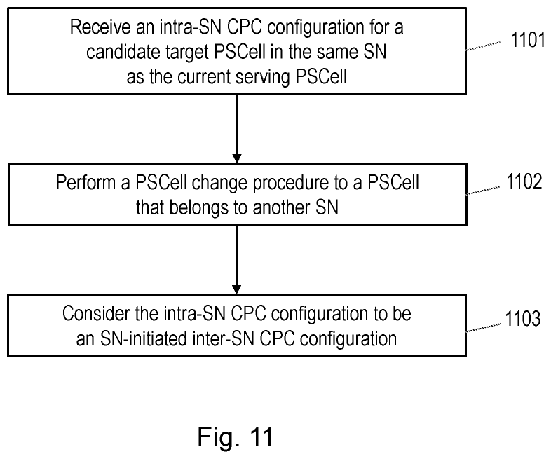

FIG. 11 is a flow chart illustrating a method performed by a UE in accordance with some embodiments. Referring to FIG. 11, the main steps performed by the UE in this example are as follows.

Step 1101. The UE receives, from a network node, at least one CPC configuration, which is for a candidate target PSCell that is located in the same SN as the current serving PSCell, i.e. an intra-SN CPC configuration. It initiates evaluation of the CPC configuration.

Step 1102. The UE performs a PSCell change procedure to a PSCell that belongs to another SN. The PSCell change procedure can be triggered by an PSCell change command or by execution of another (inter-SN) CPC configuration.

Step 1103. The UE keeps the intra-SN CPC configuration and considers it to be an SN-initiated inter-SN CPC configuration. It continues to perform evaluation for the CPC configuration.

FIG. 12 shows an example of a communication system 1200 in accordance with some embodiments.

In the example, the communication system 1200 includes a telecommunication network 1202 that includes an access network 1204, such as a radio access network (RAN), and a core network 1206, which includes one or more core network nodes 1208. The access network 1204 includes one or more access network nodes, such as network nodes 1210a and 1210b (one or more of which may be generally referred to as network nodes 1210), or any other similar 3^{rd} Generation Partnership Project (3GPP) access node or non-3GPP access point. The network nodes 1210 facilitate direct or indirect connection of user equipment (UE), such as by connecting UEs 1212a, 1212b, 1212c, and 1212d (one or more of which may be generally referred to as UEs 1212) to the core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1216 may be under the ownership or control of a service provider other than an operator or provider of the access network 1204 and/or the telecommunication network 1202, and may be operated by the service provider or on behalf of the service provider. The host 1216 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1202 is a cellular network that implements 3GPP standardized features. Accordingly, the telecommunications network 1202 may support network slicing to provide different logical networks to different devices that are connected to the telecommunication network 1202. For example, the telecommunications network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 12, the hub 1214 communicates with the access network 1204 to facilitate indirect communication between one or more UEs (e.g., UE 1212c and/or 1212d) and network nodes (e.g., network node 1210b). In some examples, the hub 1214 may be a controller, router, a content source and analytics node, or any of the other communication devices described herein regarding UEs. For example, the hub 1214 may be a broadband router enabling access to the core network 1206 for the UEs. As another example, the hub 1214 may be a controller that sends commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a VR headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular in if one or more of the UEs are low energy IoT devices.

The hub 1214 may have a constant/persistent or intermittent connection to the network node 1210b. The hub 1214 may also allow for a different communication scheme and/or schedule between the hub 1214 and UEs (e.g., UE 1212c and/or 1212d), and between the hub 1214 and the core network 1206. In other examples, the hub 1214 is connected to the core network 1206 and/or one or more UEs via a wired connection. Moreover, the hub 1214 may be configured to connect to an M2M service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub—that is, a hub whose primary function is to route communications to/from the UEs from/to the network node 1210b. In other embodiments, the hub 1214 may be a non-dedicated hub—that is, a device which is capable of operating to route communications between the UEs and network node 1210b, but which is additionally capable of operating as a communication start and/or end point for certain data channels.

FIG. 13 shows a UE 1300 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over Internet Protocol (VoIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1300 includes processing circuitry 1302 that is operatively coupled via a bus 1304 to an input/output interface 1306, a power source 1308, a memory 1310, a communication interface 1312, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 1302 is configured to process instructions and data and may be configured to implement any sequential state machine operative to execute instructions stored as machine-readable computer programs in the memory 1310. The processing circuitry 1302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1302 may include multiple central processing units (CPUs). The processing circuitry 1302 may be operable to provide, either alone or in conjunction with other UE 1300 components, such as the memory 1310, UE 1300 functionality. For example, the processing circuitry 1302 may be configured to cause the UE 1302 to perform the methods as described with reference to FIG. 6 or 9.

In the example, the input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1308 is structured as a battery or battery pack. Other types of power sources, such as an external power source (e.g., an electricity outlet), photovoltaic device, or power cell, may be used. The power source 1308 may further include power circuitry for delivering power from the power source 1308 itself, and/or an external power source, to the various parts of the UE 1300 via input circuitry or an interface such as an electrical power cable. Delivering power may be, for example, for charging of the power source 1308. Power circuitry may perform any formatting, converting, or other modification to the power from the power source 1308 to make the power suitable for the respective components of the UE 1300 to which power is supplied.

The memory 1310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1310 includes one or more application programs 1314, such as an operating system, web browser application, a widget, gadget engine, or other application, and corresponding data 1316. The memory 1310 may store, for use by the UE 1300, any of a variety of various operating systems or combinations of operating systems.

The memory 1310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a Universal Subscriber Identity Module (USIM) and/or IP Multimedia Services Subscriber Identity Module (ISIM), other memory, or any combination thereof. The UICC may for example be an embedded UICC (eUICC), integrated UICC (iUICC) or a removable UICC commonly known as ‘SIM card.’ The memory 1310 may allow the UE 1300 to access instructions, application programs and the like, stored on transitory or non-transitory memory media, to off-load data, or to upload data. An article of manufacture, such as one utilizing a communication system may be tangibly embodied as or in the memory 1310, which may be or comprise a device-readable storage medium.

The processing circuitry 1302 may be configured to communicate with an access network or other network using the communication interface 1312. The communication interface 1312 may comprise one or more communication subsystems and may include or be communicatively coupled to an antenna 1322. The communication interface 1312 may include one or more transceivers used to communicate, such as by communicating with one or more remote transceivers of another device capable of wireless communication (e.g., another UE or a network node in an access network). Each transceiver may include a transmitter 1318 and/or a receiver 1320 appropriate to provide network communications (e.g., optical, electrical, frequency allocations, and so forth). Moreover, the transmitter 1318 and receiver 1320 may be coupled to one or more antennas (e.g., antenna 1322) and may share circuit components, software or firmware, or alternatively be implemented separately.

In some embodiments, communication functions of the communication interface 1312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 1300 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node 1400 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1400 includes processing circuitry 1402, a memory 1404, a communication interface 1406, and a power source 1408, and/or any other component, or any combination thereof. The network node 1400 may be composed of multiple physically separate components (e.g., a NodeB component and a RNC component, or a BTS component and a BSC component, etc.), which may each have their own respective components. In certain scenarios in which the network node 1400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1400 may be configured to support multiple radio access technologies (RATs). In such embodiments, some components may be duplicated (e.g., separate memory 1404 for different RATs) and some components may be reused (e.g., a same antenna 1410 may be shared by different RATs). The network node 1400 may also include multiple sets of the various illustrated components for different wireless technologies integrated into network node 1400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1400.

The processing circuitry 1402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1400 components, such as the memory 1404, network node 1400 functionality.

In some embodiments, the processing circuitry 1402 includes a system on a chip (SOC). In some embodiments, the processing circuitry 1402 includes one or more of radio frequency (RF) transceiver circuitry 1412 and baseband processing circuitry 1414. In some embodiments, the radio frequency (RF) transceiver circuitry 1412 and the baseband processing circuitry 1414 may be on separate chips (or sets of chips), boards, or units, such as radio units and digital units. In alternative embodiments, part or all of RF transceiver circuitry 1412 and baseband processing circuitry 1414 may be on the same chip or set of chips, boards, or units.

The memory 1404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1402. The memory 1404 may store any suitable instructions, data, or information, including a computer program, software, an application including one or more of logic, rules, code, tables, and/or other instructions capable of being executed by the processing circuitry 1402 and utilized by the network node 1400. The memory 1404 may be used to store any calculations made by the processing circuitry 1402 and/or any data received via the communication interface 1406. In some embodiments, the processing circuitry 1402 and memory 1404 is integrated.

The communication interface 1406 is used in wired or wireless communication of signaling and/or data between a network node, access network, and/or UE. As illustrated, the communication interface 1406 comprises port(s)/terminal(s) 1416 to send and receive data, for example to and from a network over a wired connection. The communication interface 1406 also includes radio front-end circuitry 1418 that may be coupled to, or in certain embodiments a part of, the antenna 1410. Radio front-end circuitry 1418 comprises filters 1420 and amplifiers 1422. The radio front-end circuitry 1418 may be connected to an antenna 1410 and processing circuitry 1402. The radio front-end circuitry may be configured to condition signals communicated between antenna 1410 and processing circuitry 1402. The radio front-end circuitry 1418 may receive digital data that is to be sent out to other network nodes or UEs via a wireless connection. The radio front-end circuitry 1418 may convert the digital data into a radio signal having the appropriate channel and bandwidth parameters using a combination of filters 1420 and/or amplifiers 1422. The radio signal may then be transmitted via the antenna 1410. Similarly, when receiving data, the antenna 1410 may collect radio signals which are then converted into digital data by the radio front-end circuitry 1418. The digital data may be passed to the processing circuitry 1402. In other embodiments, the communication interface may comprise different components and/or different combinations of components.

In certain alternative embodiments, the network node 1400 does not include separate radio front-end circuitry 1418, instead, the processing circuitry 1402 includes radio front-end circuitry and is connected to the antenna 1410. Similarly, in some embodiments, all or some of the RF transceiver circuitry 1412 is part of the communication interface 1406. In still other embodiments, the communication interface 1406 includes one or more ports or terminals 1416, the radio front-end circuitry 1418, and the RF transceiver circuitry 1412, as part of a radio unit (not shown), and the communication interface 1406 communicates with the baseband processing circuitry 1414, which is part of a digital unit (not shown).

The antenna 1410 may include one or more antennas, or antenna arrays, configured to send and/or receive wireless signals. The antenna 1410 may be coupled to the radio front-end circuitry 1418 and may be any type of antenna capable of transmitting and receiving data and/or signals wirelessly. In certain embodiments, the antenna 1410 is separate from the network node 1400 and connectable to the network node 1400 through an interface or port.

The antenna 1410, communication interface 1406, and/or the processing circuitry 1402 may be configured to perform any receiving operations and/or certain obtaining operations described herein as being performed by the network node. Any information, data and/or signals may be received from a UE, another network node and/or any other network equipment. Similarly, the antenna 1410, the communication interface 1406, and/or the processing circuitry 1402 may be configured to perform any transmitting operations described herein as being performed by the network node. Any information, data and/or signals may be transmitted to a UE, another network node and/or any other network equipment.

The power source 1408 provides power to the various components of network node 1400 in a form suitable for the respective components (e.g., at a voltage and current level needed for each respective component). The power source 1408 may further comprise, or be coupled to, power management circuitry to supply the components of the network node 1400 with power for performing the functionality described herein. For example, the network node 1400 may be connectable to an external power source (e.g., the power grid, an electricity outlet) via an input circuitry or interface such as an electrical cable, whereby the external power source supplies power to power circuitry of the power source 1408. As a further example, the power source 1408 may comprise a source of power in the form of a battery or battery pack which is connected to, or integrated in, power circuitry. The battery may provide backup power should the external power source fail.

Embodiments of the network node 1400 may include additional components beyond those shown in FIG. 14 for providing certain aspects of the network node's functionality, including any of the functionality described herein and/or any functionality necessary to support the subject matter described herein. For example, the network node 1400 may include user interface equipment to allow input of information into the network node 1400 and to allow output of information from the network node 1400. This may allow a user to perform diagnostic, maintenance, repair, and other administrative functions for the network node 1400.

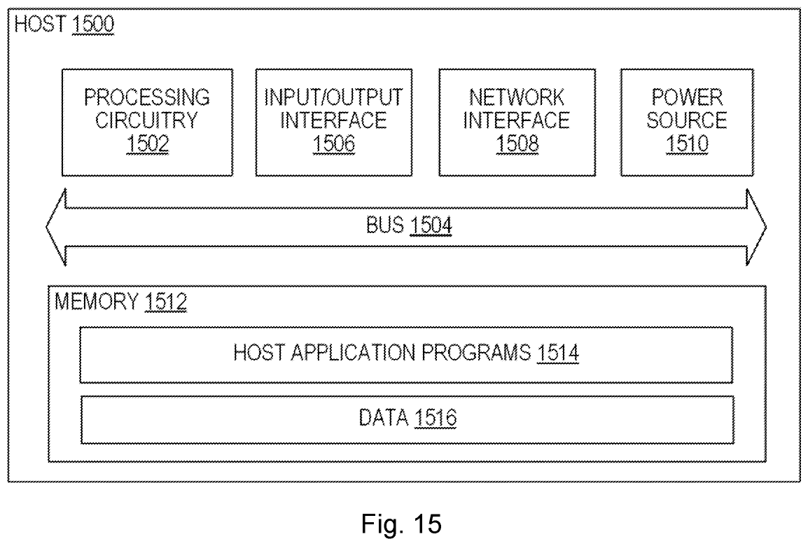

FIG. 15 is a block diagram of a host 1500, which may be an embodiment of the host 1216 of FIG. 12, in accordance with various aspects described herein. As used herein, the host 1500 may be or comprise various combinations hardware and/or software, including a standalone server, a blade server, a cloud-implemented server, a distributed server, a virtual machine, container, or processing resources in a server farm. The host 1500 may provide one or more services to one or more UEs.

The host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such as FIGS. 13 and 14, such that the descriptions thereof are generally applicable to the corresponding components of host 1500.

The memory 1512 may include one or more computer programs including one or more host application programs 1514 and data 1516, which may include user data, e.g., data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for over-the-top services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

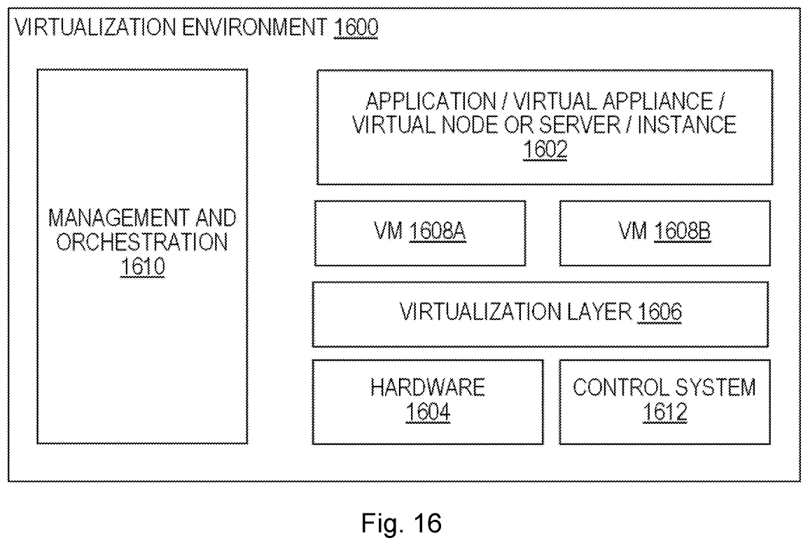

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1602 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608a and 1608b (one or more of which may be generally referred to as VMs 1608), and/or perform any of the functions, features and/or benefits described in relation with some embodiments described herein. The virtualization layer 1606 may present a virtual operating platform that appears like networking hardware to the VMs 1608.

The VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1608 may be a software implementation of a physical machine that runs programs as if they were executing on a physical, non-virtualized machine. Each of the VMs 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of the hardware 1604 and corresponds to the application 1602.

Hardware 1604 may be implemented in a standalone network node with generic or specific components. Hardware 1604 may implement some functions via virtualization. Alternatively, hardware 1604 may be part of a larger cluster of hardware (e.g. such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1612 which may alternatively be used for communication between hardware nodes and radio units.

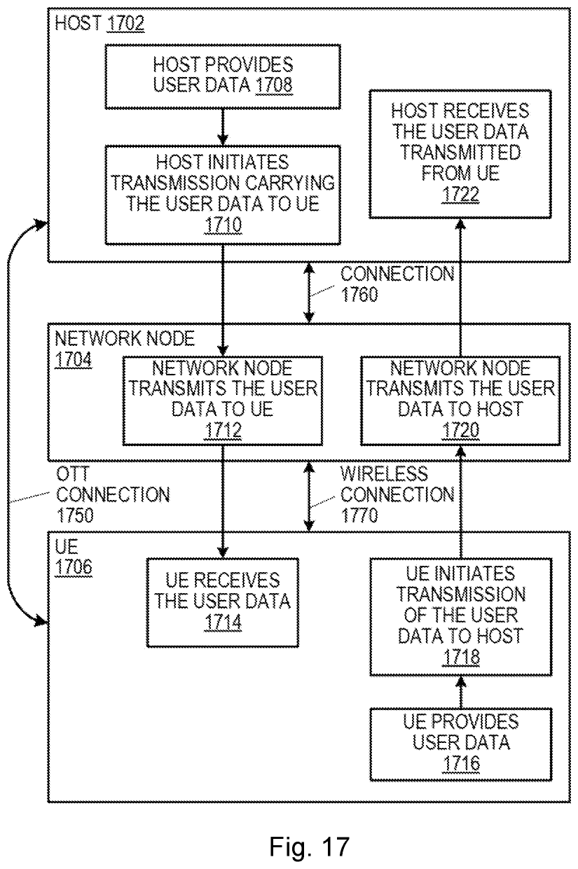

FIG. 17 shows a communication diagram of a host 1702 communicating via a network node 1704 with a UE 1706 over a partially wireless connection in accordance with some embodiments. Example implementations, in accordance with various embodiments, of the UE (such as a UE 1212a of FIG. 12 and/or UE 1300 of FIG. 13), network node (such as network node 1210a of FIG. 12 and/or network node 1400 of FIG. 14), and host (such as host 1216 of FIG. 12 and/or host 1500 of FIG. 15) discussed in the preceding paragraphs will now be described with reference to FIG. 17.

Like host 1500, embodiments of host 1702 include hardware, such as a communication interface, processing circuitry, and memory. The host 1702 also includes software, which is stored in or accessible by the host 1702 and executable by the processing circuitry. The software includes a host application that may be operable to provide a service to a remote user, such as the UE 1706 connecting via an over-the-top (OTT) connection 1750 extending between the UE 1706 and host 1702. In providing the service to the remote user, a host application may provide user data which is transmitted using the OTT connection 1750.

The network node 1704 includes hardware enabling it to communicate with the host 1702 and UE 1706. The connection 1760 may be direct or pass through a core network (like core network 1206 of FIG. 12) and/or one or more other intermediate networks, such as one or more public, private, or hosted networks. For example, an intermediate network may be a backbone network or the Internet.

The UE 1706 includes hardware and software, which is stored in or accessible by UE 1706 and executable by the UE's processing circuitry. The software includes a client application, such as a web browser or operator-specific “app” that may be operable to provide a service to a human or non-human user via UE 1706 with the support of the host 1702. In the host 1702, an executing host application may communicate with the executing client application via the OTT connection 1750 terminating at the UE 1706 and host 1702. In providing the service to the user, the UE's client application may receive request data from the host's host application and provide user data in response to the request data. The OTT connection 1750 may transfer both the request data and the user data. The UE's client application may interact with the user to generate the user data that it provides to the host application through the OTT connection 1750.

The OTT connection 1750 may extend via a connection 1760 between the host 1702 and the network node 1704 and via a wireless connection 1770 between the network node 1704 and the UE 1706 to provide the connection between the host 1702 and the UE 1706. The connection 1760 and wireless connection 1770, over which the OTT connection 1750 may be provided, have been drawn abstractly to illustrate the communication between the host 1702 and the UE 1706 via the network node 1704, without explicit reference to any intermediary devices and the precise routing of messages via these devices.

As an example of transmitting data via the OTT connection 1750, in step 1708, the host 1702 provides user data, which may be performed by executing a host application. In some embodiments, the user data is associated with a particular human user interacting with the UE 1706. In other embodiments, the user data is associated with a UE 1706 that shares data with the host 1702 without explicit human interaction. In step 1710, the host 1702 initiates a transmission carrying the user data towards the UE 1706. The host 1702 may initiate the transmission responsive to a request transmitted by the UE 1706. The request may be caused by human interaction with the UE 1706 or by operation of the client application executing on the UE 1706. The transmission may pass via the network node 1704, in accordance with the teachings of the embodiments described throughout this disclosure. Accordingly, in step 1712, the network node 1704 transmits to the UE 1706 the user data that was carried in the transmission that the host 1702 initiated, in accordance with the teachings of the embodiments described throughout this disclosure. In step 1714, the UE 1706 receives the user data carried in the transmission, which may be performed by a client application executed on the UE 1706 associated with the host application executed by the host 1702.

In some examples, the UE 1706 executes a client application which provides user data to the host 1702. The user data may be provided in reaction or response to the data received from the host 1702. Accordingly, in step 1716, the UE 1706 may provide user data, which may be performed by executing the client application. In providing the user data, the client application may further consider user input received from the user via an input/output interface of the UE 1706. Regardless of the specific manner in which the user data was provided, the UE 1706 initiates, in step 1718, transmission of the user data towards the host 1702 via the network node 1704. In step 1720, in accordance with the teachings of the embodiments described throughout this disclosure, the network node 1704 receives user data from the UE 1706 and initiates transmission of the received user data towards the host 1702. In step 1722, the host 1702 receives the user data carried in the transmission initiated by the UE 1706.

One or more of the various embodiments improve the performance of OTT services provided to the UE 1706 using the OTT connection 1750, in which the wireless connection 1770 forms the last segment. More precisely, the teachings of these embodiments may improve network efficiency and/or connection reliability.

In an example scenario, factory status information may be collected and analyzed by the host 1702. As another example, the host 1702 may process audio and video data which may have been retrieved from a UE for use in creating maps. As another example, the host 1702 may collect and analyze real-time data to assist in controlling vehicle congestion (e.g., controlling traffic lights). As another example, the host 1702 may store surveillance video uploaded by a UE. As another example, the host 1702 may store or control access to media content such as video, audio, VR or AR which it can broadcast, multicast or unicast to UEs. As other examples, the host 1702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1750 between the host 1702 and UE 1706, in response to variations in the measurement results. The measurement procedure and/or the network functionality for reconfiguring the OTT connection may be implemented in software and hardware of the host 1702 and/or UE 1706. In some embodiments, sensors (not shown) may be deployed in or in association with other devices through which the OTT connection 1750 passes; the sensors may participate in the measurement procedure by supplying values of the monitored quantities exemplified above, or supplying values of other physical quantities from which software may compute or estimate the monitored quantities. The reconfiguring of the OTT connection 1750 may include message format, retransmission settings, preferred routing etc.; the reconfiguring need not directly alter the operation of the network node 1704. Such procedures and functionalities may be known and practiced in the art. In certain embodiments, measurements may involve proprietary UE signaling that facilitates measurements of throughput, propagation times, latency and the like, by the host 1702. The measurements may be implemented in that software causes messages to be transmitted, in particular empty or ‘dummy’ messages, using the OTT connection 1750 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EMBODIMENTS

### Group A Embodiments

1. A method performed by a User Equipment (UE) for executing an inter-secondary node (SN) Primary SCell (PSCell) change, the method comprising:
   executing an inter-SN PSCell change to a target PSCell; and
   performing one or more of:
      converting at least one first intra-SN Conditional PSCell Change (CPC) configuration in the UE to at least one first inter-SN CPC configuration; and/or
      converting at least one second inter-SN CPC configuration in the UE to at least one second intra-SN CPC configuration if a candidate PSCell of the at least one inter-SN CPC configuration is associated with the same SN as the target PSCell.
2. The method of embodiment 1, wherein the inter-SN PSCell change to the target PSCell comprises an inter-SN CPC.
3. The method of embodiment 1 or 2, wherein:
   converting the at least one first intra-SN CPC configuration to the at least one first inter-SN CPC configuration comprises executing a procedure associated with one of the at least one first intra-SN CPC configuration as an inter-SN CPC configuration when a condition associated with the at least one first intra-SN CPC configuration is fulfilled; and/or
   converting the at least one second inter-SN CPC configuration to the at least one second intra-SN CPC configuration comprises executing a procedure associated with one of the at least one first intra-SN CPC configuration as an intra-SN CPC configuration when a condition associated with the at least one second inter-SN CPC configuration is fulfilled.
4. The method of embodiment 3, wherein:
   executing the procedure associated with one of the at least one first intra-SN CPC configuration as an inter-SN CPC configuration comprises, on completion of execution of the procedure, sending a RRCReconfigurationComplete message to a Master Node (MN) associated with the UE, wherein the RRCReconfigurationComplete message to the MN includes an RRCReconfigurationComplete message to the SN associated with the target PSCell.
5. The method of embodiment 4, wherein the RRCReconfigurationComplete message to the MN includes information identifying the SN associated with the target PSCell.
6. The method of any of embodiments 1 to 5, wherein converting the at least one first intra-SN CPC configuration to the at least one first inter-SN CPC configuration comprises:
   storing the at least one SN CPC configuration as at least one Master Node (MN)-initiated inter-SN CPC configuration; or
   storing the at least one SN CPC configuration as at least one SN-initiated inter-SN CPC configuration.
7. The method of embodiment 6, wherein:
   the at least one MN-initiated inter-SN CPC configuration is stored in a Master Cell Group (MCG) VarConditionalReconfig of the UE; or
   the at least one SN-initiated inter-SN CPC configuration is stored in a Secondary Cell Group (SCG) VarConditionalReconfig of the UE.
8. The method of any of embodiments 3 to 7, wherein executing the procedure associated with one of the at least one first intra-SN CPC configuration as an intra-SN CPC configuration comprises:
   if Signalling Radio Bearer 3 (SRB3) is not configured for the target PSCell, on completion of execution of the procedure, sending a ULInformation TransferMRDC message to a Master Node (MN) associated with the UE, wherein the ULInformation TransferMRDC message to the MN includes an RRCReconfigurationComplete message to the SN associated with the target PSCell; and/or
   if SRB3 is configured for the target PSCell, on completion of execution of the procedure, sending a RRCReconfigurationComplete message to the SN associated with the target PSCell.
9. The method of any of embodiments 1 to 8, comprising sending, to the SN associated with the target PSCell or a Master Node (MN) associated with the UE, information identifying the at least one first intra-SN CPC configuration and/or the at least one second inter-SN CPC configuration.
10. The method of embodiment 9, wherein the information is sent in a RRC Reconfiguration Complete message.
11. The method of any of embodiments 1 to 10, wherein the at least one second intra-SN CPC configuration is stored in a Secondary Cell Group (SCG) VarConditionalReconfig of the UE.
12. The method of any of embodiments 1 to 11, comprising maintaining at least one further inter-SN CPC configuration, wherein a candidate PSCell of the at least one further inter-SN CPC configuration is associated with a different SN as the target PSCell.
13. The method of any of embodiments 1 to 12, wherein:
   converting the at least one first intra-SN Conditional PSCell Change (CPC) configuration in the UE to the at least one first inter-SN CPC configuration is performed in response to an indication identifying the at least one first intra-SN CPC configuration; and/or
   converting the at least one second inter-SN CPC configuration in the UE to the at least one second intra-SN CPC configuration is performed in response to an indication identifying the at least one first inter-SN CPC configuration.
14. The method of embodiment 13, wherein the indication is received from the SN associated with the target PSCell, a SN associated with a serving PSCell, or a Master Node (MN) associated with the UE.
15. The method of any of embodiments 1 to 14, wherein the UE is configured with at least one additional CPC configuration, wherein each additional CPC configuration includes one or more first conditions for executing an intra-SN CPC procedure to a first candidate PSCell and one or more second conditions for executing an inter-SN CPC procedure to a second candidate PSCell.
16. The method of embodiment 15, comprising:
   executing the intra-SN CPC procedure to the first candidate PSCell if the one or more first conditions are fulfilled and the first candidate PSCell is associated with the same SN as a serving PSCell; and/or
   executing the inter-SN CPC procedure to the second candidate PSCell if the one or more second conditions are fulfilled and the second candidate PSCell is associated with a different SN to the serving PSCell.
17. The method of any of embodiments 1 to 16, comprising deactivating, deleting and/or releasing one or more of the at least one first intra-SN CPC configuration and/or one or more of the at least one second inter-SN CPC configuration after executing the inter-SN PSCell change to the target PSCell.
18. The method of embodiment 17, comprising receiving, from a master node (MN) associated with the UE, the SN associated with the target PSCell, or a SN associated with a serving PSCell, an indication identifying the one or more of the at least one first intra-SN CPC configuration and/or one or more of the at least one second inter-SN CPC configuration to deactivate, delete and/or release.
19. The method of embodiment 17 or 18, wherein deactivating the one or more of the at least one first intra-SN CPC configuration and/or the one or more of the at least one second inter-SN CPC configuration comprises not evaluating whether execution conditions for the one or more of the at least one first intra-SN CPC configuration and/or the one or more of the at least one second inter-SN CPC configuration have been fulfilled, or not executing a procedure associated with the one or more of the at least one first intra-SN CPC configuration and/or the one or more of the at least one second inter-SN CPC configuration on determining that the execution conditions have been fulfilled.
20. The method of any of embodiments 17 to 19, comprising reactivating the one or more of the at least one first intra-SN CPC configuration after performing a later inter-SN PSCell change to a further target PSCell associated with the same SN as a candidate PSCell associated with the one or more of the at least one first intra-SN CPC configuration.
21. The method of any of embodiments 17 to 20, wherein deactivating the one or more of the at least one second inter-SN CPC configuration is performed after executing the inter-SN PSCell change to the target PSCell, wherein the one or more of the at least one second inter-SN CPC configuration has a candidate PSCell that is associated with the same SN as the target PSCell.
22. The method of embodiment 21, comprising reactivating the one or more of the at least one second inter-SN CPC configuration after performing a later inter-SN PSCell change to a further target PSCell associated with a different SN than the candidate PSCell associated with the one or more of the at least one second inter-SN CPC configuration 23. The method of any of embodiments 1 to 22, comprising receiving, from a master node (MN) associated with the UE, the SN associated with the target PSCell, or a SN associated with a serving PSCell, a configuration for the inter-SN PSCell change to the target PSCell.
24. The method of embodiment 23, wherein the configuration for the inter-SN PSCell change to the target PSCell includes one or more further intra-SN CPC configurations for the UE for one or more candidate PSCells associated with the same SN as the target PSCell. 25. The method of any of embodiments 1 to 24, wherein one of the at least one first intra-SN CPC configuration has the same candidate PSCell as one of the at least one second inter-SN CPC configuration.
26. The method of embodiment 25, wherein, if execution conditions for the one of the at least one first intra-SN CPC configuration are fulfilled and execution conditions for the one of the at least one second inter-SN CPC configuration have been fulfilled:
   prioritizing execution of a procedure associated with the one of the at least one first intra-SN CPC configuration; or
   prioritizing execution of a procedure associated with the one of the at least one second inter-SN CPC configuration.
27. The method of embodiment 26, wherein:
   prioritizing execution of a procedure associated with the one of the at least one first intra-SN CPC configuration comprises determining that the execution conditions for the one of the at least one first intra-SN CPC configuration are fulfilled without determining whether execution conditions for the one of the at least one second inter-SN CPC configuration have been fulfilled; and/or
   prioritizing execution of a procedure associated with the one of the at least one second inter-SN CPC configuration comprises determining that the execution conditions for the one of the at least one second inter-SN CPC configuration are fulfilled without determining whether execution conditions for the one of the at least one-SN CPC configuration have been fulfilled.
28. The method of any of embodiments 1 to 27, wherein each of the at least one first intra-SN CPC configuration and/or each of the at least one second inter-SN CPC configuration identifies a SN associated with a target PSCell for the CPC configuration.
29. The method of any of embodiments 1 to 28, comprising receiving, from a master node (MN) associated with the UE, the SN associated with the target PSCell, or a SN associated with a serving PSCell, an indication that the inter-SN PSCell change to the target PSCell is an inter-SN PSCell change.
30. The method of embodiment 29, wherein the indication comprises an indication that the target PSCell is associated with a different SN than a serving PSCell.
31. The method of any of embodiments 1 to 30, wherein executing the inter-SN PSCell change to the target PSCell is performed on initiation by a master node (MN) associated with the UE, the SN associated with the target PSCell, or a SN associated with a serving PSCell.
32. The method of any of embodiments 1 to 31, comprising:
   receiving the at least one first intra-SN CPC configuration from a master node (MN) associated with the UE or a SN associated with a serving PSCell; and/or
   receiving the at least one second inter-SN CPC configuration from the MN, the SN associated with a serving PSCell and/or the SN associated with the target PSCell.
33. The method of any of embodiments 1 to 32, wherein the SN associated with the target PSCell comprises a SN that controls and/or manages the target PSCell.
34. The method of any of embodiments 1 to 33, wherein the inter-SN PSCell change to the target PSCell comprises a change to the target PSCell wherein the target PSCell is associated with a different secondary node to a secondary node associated with a serving PSCell.
35. The method of any of embodiments 1 to 34, wherein the secondary node associated with the target PSCell comprises a gNodeB, Central Unit gNodeB (CU-gNB), eNodeB, Central Unit eNodeB (CU-eNB), or any network node and/or network function.
36. The method of any of embodiments 1 to 35, wherein the inter-SN PSCell change to the target PSCell comprises a change of a serving PSCell from a current serving PSCell to the target PSCell, or addition of the target PSCell.
37. The method of any of the previous embodiments, further comprising:
   providing user data; and
   forwarding the user data to a host via the transmission to the network node.

### Group C Embodiments

38. A user equipment for [insert purpose], comprising:
   processing circuitry configured to cause the user equipment to perform any of the steps of any of the Group A embodiments; and
   power supply circuitry configured to supply power to the processing circuitry.
39. A user equipment (UE) for [insert purpose], the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE
40. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to receive the user data from the host.
41. The host of the previous embodiment, wherein the cellular network further includes a network node configured to communicate with the UE to transmit the user data to the UE from the host.
42. The host of the previous 2 embodiments, wherein:
   the processing circuitry of the host is configured to execute a host application, thereby providing the user data; and
   the host application is configured to interact with a client application executing on the UE, the client application being associated with the host application.
43. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the Group A embodiments to receive the user data from the host.
44. The method of the previous embodiment, further comprising:
   at the host, executing a host application associated with a client application executing on the UE to receive the user data from the UE.
45. The method of the previous embodiment, further comprising:
   at the host, transmitting input data to the client application executing on the UE, the input data being provided by executing the host application,
   wherein the user data is provided by the client application in response to the input data from the host application.
46. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to transmit the user data to the host.
47. The host of the previous embodiment, wherein the cellular network further includes a network node configured to communicate with the UE to transmit the user data from the UE to the host.
48. The host of the previous 2 embodiments, wherein:
   the processing circuitry of the host is configured to execute a host application, thereby providing the user data; and
   the host application is configured to interact with a client application executing on the UE, the client application being associated with the host application.
49. A method implemented by a host configured to operate in a communication system that further includes a network node and a user equipment (UE), the method comprising:
   at the host, receiving user data transmitted to the host via the network node by the UE, wherein the UE performs any of the steps of any of the Group A embodiments to transmit the user data to the host.
50. The method of the previous embodiment, further comprising:
   at the host, executing a host application associated with a client application executing on the UE to receive the user data from the UE.
51. The method of the previous embodiment, further comprising:
   at the host, transmitting input data to the client application executing on the UE, the input data being provided by executing the host application,
   wherein the user data is provided by the client application in response to the input data from the host application.

1. A method performed by a User Equipment, UE, operating in Dual Connectivity, DC, with a Master Node, MN, and a serving Secondary Node, SN, the method comprising:
receiving, from the MN, a conditional PSCell change, CPC, configuration for a first candidate target PSCell of the serving SN, wherein the CPC configuration is in MN format.

2. The method of claim 1, wherein receiving the CPC configuration for the first candidate target PSCell in MN format comprises receiving an RRCReconfiguration message in which the CPC configuration for the first candidate target PSCell is comprised in a field other than mrdc-SecondaryCellGroup.

3. The method of claim 1, further comprising:
storing the CPC configuration for the first candidate target PSCell in a Master Cell Group, MCG, VarConditionalReconfig UE variable.

4. The method of claim 1, further comprising:
receiving, from the MN, a CPC configuration for a second candidate target PSCell of a different SN to the serving SN, wherein the CPC configuration for the second candidate target PSCell is in MN format.

5. The method of claim 4, further comprising:
storing the CPC configuration for the second candidate target PSCell in a Master Cell Group, MCG, VarConditionalReconfig UE variable.

6. The method of claim 4, further comprising:
after receiving the CPC configuration for the first candidate target PSCell and the CPC configuration for the second candidate target PSCell, executing an inter-SN CPC to the second candidate target PSCell.

7. The method of claim 6, further comprising:
after executing the inter-SN CPC to the second candidate target PSCell, keeping the received CPC configuration for the first candidate target PSCell.

8. The method of claim 6, further comprising:
after executing the inter-SN CPC to the second candidate target PSCell, evaluating an execution condition associated with the received CPC configuration for the first candidate target PSCell.

9. The method of claim 4, further comprising:
after receiving the CPC configuration for the second candidate target PSCell, executing an inter-SN CPC to a third candidate target PSCell, wherein the third candidate target PSCell is in the same SN as the second candidate target PSCell.

10. The method of claim 9, further comprising:
after executing the inter-SN CPC to the third candidate PSCell, keeping the received CPC configuration for the second candidate target PSCell.

11. The method of claim 9, further comprising:
after executing the inter-SN CPC to the third candidate target PSCell, evaluating an execution condition associated with the received CPC configuration for the second candidate target PSCell.

12. The method of claim 1, wherein the serving SN controls a secondary cell group, SCG, and the method further comprises:
after receiving the CPC configuration for the first candidate target PSCell, releasing the SCG controlled by the serving SN and keeping the received CPC configuration for the first candidate target PSCell.

13. The method of claim 12, further comprising:
after releasing the SCG, evaluating an execution condition associated with the received CPC configuration for the first candidate target PSCell.

14. The method of claim 1, wherein the CPC configuration for the first candidate target PSCell is received together with one or more associated execution conditions for the CPC configuration for the first candidate target PSCell.

15. The method of any claim 1, wherein the CPC configuration for the first candidate target PSCell is received with a first indication that the CPC configuration for the first candidate target PSCell can be kept at a cell change procedure.

16. The method of any claim 1, wherein the CPC configuration for the first candidate target PSCell is received with a first identifier for the serving SN to which the first candidate target PSCell belongs.

17. The method of claim 16 of claim 4, wherein the CPC configuration for the second candidate target PSCell is received with a second identifier for the SN to which the second candidate target PSCell belongs.

18. The method of claim 17, further comprising:
determining, based on the first identifier and the second identifier, that the first candidate target PSCell and the second candidate target PSCell belong to different SNs.

19. The method of claim 1, wherein the UE is operating in New Radio Dual Connectivity, NR-DC, with the MN and the serving SN.

20-38. (canceled)

39. A user equipment, UE, comprising a processor and a memory, said memory containing instructions executable by said processor whereby said UE is operative to operate in Dual Connectivity, DC, with a Master Node, MN, and a serving Secondary Node, SN, wherein the UE is further operative to:
receive, from the MN, a conditional PSCell change, CPC, configuration for a first candidate target PSCell of the serving SN, wherein the CPC configuration is in MN format.

40. The UE of claim 39, wherein receiving the CPC configuration for the first candidate target PSCell in MN format comprises receiving an RRCReconfiguration message in which the CPC configuration for the first candidate target PSCell is comprised in a field other than mrdc-SecondaryCellGroup.

41-49. (canceled)
